(19) United States
(12) Patent Application Publication
(10) Pub. No.: US 2012/0282522 A1
(43) Pub. Date: Nov. 8, 2012

(54) Spray Pyrolysis Synthesis of Mesoporous Positive Electrode Materials for High Energy Lithium-Ion Batteries

(75) Inventors: Richard L. Axelbaum, St. Louis, MO (US); Xiaofeng Zhang, St. Louis, MO (US)

(73) Assignee: Washington University, St. Louis, MO (US)

(21) Appl. No.: 13/462,563

(22) Filed: May 2, 2012

Related U.S. Application Data
(60) Provisional application No. 61/481,601, filed on May 2, 2011.

(51) Int. Cl. H01M 4/131; H01M 10/0525; H01M 4/1315

(52) U.S. Cl. 429/219; 429/223; 429/221; 429/220; 264/12

(57) ABSTRACT

A lithium metal oxide positive electrode material useful in making lithium-ion batteries that is produced using spray pyrolysis. The material comprises a plurality of metal oxide secondary particles that comprise metal oxide primary particles, wherein the primary particles have a size that is in the range of about 1 nm to about 10 μm, and the secondary particles have a size that is in the range of about 10 nm to about 100 μm and are uniformly mesoporous.

### CROSS-REFERENCE TO RELATED APPLICATIONS

The present application is a non-provisional application claiming the benefit of U.S. Provisional Application No. 61/481,601, filed May 2, 2011, which is incorporated herein by reference in its entirety.

### STATEMENT REGARDING FEDERALLY SPONSORED RESEARCH OR DEVELOPMENT

This invention was made with Government Support under a grant from the National Science Foundation (grant CBET-0928964). The government has certain rights to this invention.

### FIELD OF THE INVENTION

The invention is generally related to active materials for battery applications. More specifically, the invention relates to fine structured positive active materials and methods for preparing them for use in lithium-ion batteries.

### BACKGROUND OF INVENTION

Lithium-ion secondary batteries are considered an attractive power source for portable devices, electric, hybrid electric vehicles, and large renewable power facilities. A Li-ion cell is comprised of an anode and a cathode, separated by a porous separator. The anode is normally graphite with a practical reversible capacity of 350 mAhg⁻¹. To meet the growing demands of high-energy and high-power rechargeable batteries, cathode materials must be lightweight, safe, and non-toxic, with a high energy density and high cycleability. Among the known cathode materials, layered LiMO₂ (M═Co, Mn, Ni), lithium spinets Li[M₂]O₄, (M═V, Ti, or Mn), and olivine-type lithium iron phosphate (LiFePO₄) are being commercialized for lithium rechargeable batteries. Cobalt is toxic and less abundant, thus making it costly compared to Fe, Mn, and Ni. Advantageously, spinel LiMn₂O₄ has a flat voltage plateau at 3 V and 4 V, however, severe capacity fading at deep discharge makes it impractical for high-energy battery applications. The layered LiMnO₂ has a higher theoretical capacity than spinel LiMn₂O₄, however, a layered-spinel transformation is observed for LiMnO₂ cells, which tends to induce capacity fading. LiFePO₄ is considered the safest these cathode materials but pure LiFePO₄ suffers from a low conductivity at room temperature, compared to LiCoO₂ and LiMn₂O₄. Furthermore, none of the above materials have shown a capacity higher than 200 mAhg⁻¹ and good capacity retention.

Many efforts have been reported to increase the capacity of Mn-based materials by adopting a composite structure. Among them, the Li-rich Li[Li_{(1/3-2a/3)}NiₐMn_{(2/3-a/3)}]O₂ (0<a<½) synthesized at high temperature can deliver over 200 mAhg⁻¹ at low current density, between C/20 and C/50. The layered compounds are considered to be an integration of two layered materials Li₂MnO₃ (C2/m) and LiMn_{0.5}Ni_{0.5}O₂ (R 3̅m) forming a rock-salt-type a-NaFeO₂ structure with R 3̅m space group, which are often described as layered-layered integrated composites yLi₂MnO₃.(1−y)LiMn_{0.5}Ni_{0.5}O₂ (where 0≦y≦1). The two chemical formulas are equivalent by the relationship: a=(1−y)/(1+2y). It is believed that the cation disordering in the transition metal layer between Li₂MnO₃ and LiMn_{0.5}Ni_{0.5}O₂ improves the stability of the overall structure, thus enhancing the cycling life. The initial charge of these layered-layered composite materials involves extraction of Li+ and release of oxygen with a net loss of Li₂O, which occurs above 4.5 V versus Li. A surface treatment involving acid etching and surface coating with phosphate is known to enhance the rate and cycle capabilities and improve the columbic efficiency of these materials but adds complexity to the synthesis processes.

Recently, a layered-spinel integrated composite lithium-nickel-manganese oxide Li_{1.375}Mn_{0.75}Ni_{0.25}O_{2.4375} within the LiMn_{1.5}Ni_{0.5}O₄—Li₂MnO₃—LiMn_{0.5}Ni_{0.5}O₂ system was developed and exhibits promising rate capabilities and cycle life.⁵⁻⁸ In particular, the Li_{1.375}Mn_{0.75}Ni_{0.25}O_{2.4375} was reported to deliver 200 mAhg⁻¹ at a current density of 230 mAg⁻¹, which was one of the highest reported capacities among the Li-rich high-energy cathode materials.⁸ This high performance was reported to be due, at least in part, to the layered-spinel integrated structure and the porous morphology composed of nano-sized primary particles. This class of lithium-nickel-manganese oxide has a general formula of Li₍₁₊ₓ₎Mn_{0.75}Ni_{0.25}O_{(2.25+x/2)}(0≦x≦½), wherein the oxidation states of the metals are considered to be [Li⁺], [Mn⁴⁺], and [Ni²⁺]. After a simple calculation, Li_{1.375}Mn_{0.75}Ni_{0.25}O_{2.4375} can be expressed as Li_{1.1}Mn_{0.6}Ni_{0.2}O_{1.95}, with a general formula of Li_{(1.2-δ)}Mn_{0.6}Ni_{0.2}O_{(2-δ/2)} (0≦δ≦ 1/10).

The process for synthesizing the aforementioned lithium-nickel-manganese oxide includes co-precipitation of transition metal carbonates or hydroxides, post-lithiation, and calcination at high-temperature.^{7,8} This process resulted in a powder that was polycrystalline and may have a core-shell structure, wherein the core region has a different electron diffraction pattern and preferred-growth direction than that of the shell region.⁸ While the reported performance of this powder is considered to be excellent, the synthesis process is multistep, slow, energy intensive, costly, prone to variability, and produces considerable waste. Furthermore, the particle size and morphology are constrained by the co-precipitation method and are believed to be far from ideal, particularly when the method is applied at commercial scale. Irregular particles, tens of microns in size and often with a cracked interior, may be produced and particle-to-particle and batch-to-batch consistency is a challenge.

In view of the foregoing, a need exists for positive active materials for use in lithium-ion batteries with improved size and morphology and methods for preparing them that are simpler, easier to control, faster, less energy intensive, less costly, more reproducible, and with less waste.

### SUMMARY OF INVENTION

The present invention is directed to a material comprising a plurality of metal oxide secondary particles that comprise metal oxide primary particles, which comprise a metal oxide having a general chemical formula Li_{1+α}(NiₓCo_{y}Mn_{z})₁₋MₜO_{2-d}R_{d}, wherein:
M is selected from a group consisting of Al, Mg, Fe, Cu, Zn, Cr, Ag, Ca, Na, K, In, Ga, Ge, V, Mo, Nb, Si, Ti, Zr, and mixtures thereof;
R is selected from a group consisting of F, Cl, Br, I, H, S, N, and mixtures thereof; and
0≦α≦0.50; 0<x≦1; 0≦y≦1; 0<z≦1;0≦t≦1; and 0≦d≦0.5; and
wherein the primary particles have a size that is in the range of about 1 nm to about 10 μm; and
wherein the secondary particles have a size that is in the range of about 10 nm to about 100 μm and are uniformly mesoporous.

The present invention is also directed to a process for preparing the foregoing metal oxide material, the process comprising: aerosolizing a precursor solution that comprises compounds that are precursors to the metal oxide material in a solvent to form droplets that comprise the precursor solution; evaporating the solution in the droplets to form dried droplets that comprise the precursor compounds; calcining (or decomposing) the dried droplets to form the metal oxide material that comprises a plurality of metal oxide secondary particles that comprise metal oxide primary particles.

Additionally, the present invention is directed to a battery comprising a negative electrode, a positive electrode that comprises the foregoing metal oxide material and an electrolyte.

### BRIEF DESCRIPTION OF THE DRAWINGS

FIG. 1 is a schematic of one embodiment of a spray pyrolysis system.

FIG. 2 is a graph of particle size distribution for two different methods of aerosolizing the solutions.

FIG. 3 is a graph of the decomposition temperature profiles of Mn(NO₃)₂, LiNO₃, LiNO₃ and Mn(NO₃)₂, and LiNO₃ and Mn(NO₃)₂ and Ni(NO₃)₂.

FIG. 4 is a SEM image of layered composite Li_{1.2}Mn_{0.6}Ni_{0.2}O₂ powder material produced via spray pyrolysis before being annealed.

FIG. 5 is a SEM image showing the nanostructured morphology of layered composite material Li_{1.2}Mn_{0.6}Ni_{0.2}O₂ powder material produced via spray pyrolysis before being annealed.

FIG. 6 is an XRD pattern of layered composite material Li_{1.2}Mn_{0.6}Ni_{0.2}O₂ material produced via spray pyrolysis before being annealed.

FIG. 7 is a SEM image showing the mesoporous morphology of showing the nanostructured layered composite material Li_{1.2}Mn_{0.6}Ni_{0.2}O₂ material produced via spray pyrolysis after being annealed at 800° C. for 2 hours.

FIG. 8 contains XRD patterns of layered composite material xLi₂MnO₃.(1−x)LiMn_{0.5}Ni_{0.5}O₂, wherein x is 0.3, 0.4, 0.5, 0.6, and 0.7.

FIG. 9 contains XRD patterns of C2/m, R 3̅m, R 3̅m+Fd 3̅m an_{d} Fd ^{3̅}m space groups.

FIG. 10 contains XRD patterns of nanostructured lithium nickel manganese oxides: (a) spinel LiMn_{1.5}Ni_{0.5}O₄ synthesized at 700° C. annealed at 700° C. for 2 hours; (b) spinel-layered integrated Li_{1.1}Mn_{0.6}Ni_{0.2}O_{1.95} synthesized at 700° C. annealed at 700° C. for 2 hours; (c) layered composite material Li_{1.2}Mn_{0.5}Ni_{0.2}O₂ synthesized at 700° C. annealed at 800° C. for 2 hours.

FIG. 11 is a XRD pattern of the Li_{(1.2-δ)}Mn_{0.6}Ni_{0.2}O_{(2-δ/2)} (δ=0, 1/20, 1/10) powders after annealing treatment, wherein (a) is for δ=0, (b) is for δ= 1/20, and (c) is for δ= 1/10, and wherein the arrows indicate the broadening of the peaks and the solid circles show the splitting and separation of peaks, which indicates the formation of Li₂MnO₃-type structures.

FIG. 12 contains the as-estimated lattice parameters of Li_{(1.2-δ)}Mn_{0.6}Ni_{0.2}O_{(2-δ/2)} for different Li-contents.

FIG. 13 contains SEM images showing the morphology of the Li-deficient powders annealed at 700° C. and 800° C., wherein (a) and (b) are for Li_{1.2}Mn_{0.6}Ni_{0.2}O₂, (c) and (d) are for Li_{1.15}Mn_{0.6}Ni_{0.2}O_{1.975}, and (e) and (f) are for Li_{1.1}Mn_{0.6}Ni_{0.2}O_{1.95}.

FIG. 14 contains TEM images of the Li_{1.2}Mn_{0.6}Ni_{0.2}O₂ (800° C.) powders, wherein (a) shows the morphology of a particle and (b) shows a cross-section of the particles sliced using a microtome.

FIG. 15 contains HR-TEM images of microstructures of (a) Li_{1.2}Mn_{0.6}Ni_{0.2}O₂(800° C.) powder and (b) Li_{1.1}Mn_{0.6}Ni_{0.2}O_{1.95} (700° C.) powder, wherein the circles indicate the nano-domains of spinel structure that integrated to the layered structure.

FIG. 16 contains graphs of the initial charge/discharge voltage profiles of the cells at a constant current of 11.5 mAg⁻¹ between 2.0 and 4.9 V for (a) Li_{1.2}Mn_{0.6}Ni_{0.2}O₂, (b) Li_{1.15}Mn_{0.6}Ni_{0.2}O_{1.975}, and (c) Li_{1.1}Mn_{0.6}Ni_{0.2}O_{1.95}, wherein the dashed line represent the 700° C. annealing temperature and the solid line represent the at 800° C. annealing temperature.

FIG. 17 contains graphs of the cycling performance of the cells at a constant current of 23 mAg⁻¹ between 2.0 and 4.8 V for (a) Li_{1.2}Mn_{0.6}Ni_{0.2}O₂, (b) Li_{1.15}Mn_{0.6}Ni_{0.2}O_{1.975}, and (c) Li_{1.1}Mn_{0.6}Ni_{0.2}O_{1.95}, wherein the triangles represent 700° C. the annealing temperature and the circles represent the 800° C. annealing temperature.

FIG. 18 contains graphs of the cycling performance of the cells activated at a constant current of 11.5 mAg⁻¹ between 2.0 and 4.9 V, and future cycled at 23 mAg⁻¹ between 2.0 and 4.8 V for (a) Li_{1.2}Mn_{0.6}Ni_{0.2}O₂, (b) Li_{1.15}Mn_{0.6}Ni_{0.2}O_{1.975}, and (c) Li_{1.1}Mn_{0.6}Ni_{0.2}O_{1.95}, wherein circles represent the 800° C. annealing temperature.

FIG. 19 contains graphs of the cycling performance of the cells at elevated current density between 2.0 and 4.9 V: (a) Li_{1.2}Mn_{0.6}Ni_{0.2}O₂ (800° C.); and (b) Li_{1.1}Mn_{0.6}Ni_{0.2}O_{1.95} (700° C.). Coulombic efficiency corresponding to each charge/discharge cycle is calculated and plotted, as shown.

FIG. 20 contains a graph of the cycling performance of a cell at elevated current density between 2 and 4.6 V at room temperature for Li_{1.2}Mn_{0.53}Ni_{0.13}Co_{0.13}O₂ (900° C.).

FIG. 21 contains a graph of the cycling performance of a cell at elevated current density between 2 and 4.6 V at 55° C. for Li_{1.2}Mn_{0.53}Ni_{0.13}Co_{0.13}O₂(900° C.).

### DETAILED DESCRIPTION OF INVENTION

The present invention is directed, at least in part, to preparing lithium-ion battery cathode active materials by a method that involves spray pyrolysis. Spray pyrolysis has been widely used for ceramic powder production at industrial scale, including for production of simple metal oxides (TiO₂, Fe₂O₃, etc.), complex metal oxides (BaTiO₃, NiFe₂O₄, etc.), and semiconductors (YBa₂Cu₃O₇₋ₓ, Bi—Sr—Ca—Cu—O oxides, etc.). Over the past decade, spray technologies have begun to be applied to the synthesis of cathode materials for Li-ion batteries. For example, spray pyrolysis and spray drying have been used to produce transition metal oxides and phosphate such as LiMn₂O₄, LiCoO₂, LiNi_{0.5}Mn_{1.5}O₄, and LiFePO₄. But none of the previously reported Li-ion cathode powders prepared via spray pyrolysis achieved a capacity approaching 250 mAhg⁻¹.

Spray pyrolysis is believed to offer several advantages over co-precipitation for the formation of Li-ion cathode materials of the present invention. For example, a spray pyrolysis process tends to be more environmentally friendly, less resource and capital intensive, simpler, and faster than co-precipitation. Further, the process allows for the produced materials to have the unique physical characteristics described herein and greater uniformity and control of chemical composition within a primary particle, from primary particle-to-primary particle, within a secondary particle, from secondary particle-to-secondary particle, and from batch-to-batch. Still further, no precipitation/chelating agent is required with spray pyrolysis.

Regarding the uniformity of composition of a particle, it may be quantified by slicing a secondary particle with, for example, a microtome and determining the elemental composition at 100 randomly selected regions of the sliced secondary particle with, for example, an electron microprobe using EDX, with a spatial resolution of 1 micrometer. It is to be noted that lithium is not detectable by EDX but all other elements of interest are. The standard deviation of the detected composition of each element may then be determined. In one embodiment, cathode material powders of the present invention may be produced such that the measured relative concentration of each element therein has a standard deviation that is no greater than about 4% and that the composition of an individual particle or region does not vary from the eman by more than 4%. In another embodiment, the standard deviation of the measured concentration of each element is no greater than about 2% and that of an individual particle or region does not vary from the mean by more than 2%. In yet another embodiment, the standard deviation of the measured concentration of each element is no greater than about 1% and that of an individual particle or region does not vary from the mean by more than 1%.

By controlling the various parameters of this method, in conjunction with the selection of the oxide composition, and optional post-pyrolysis heat treatments, porous high-energy (e.g., a capacity over 200 mAhg⁻¹ or even 250 mAhg⁻¹) cathode materials may be produced. More specifically, it has been found that the morphology of an active material may affect the electrochemical performance and packing density of an electrode, which are known to impact battery performance. The process of the present invention may be controlled to produce positive electrode materials that have one or more of the following characteristics: relatively high specific capacity, packing density, specific energy density, rate capability, and enhanced cycling performance.

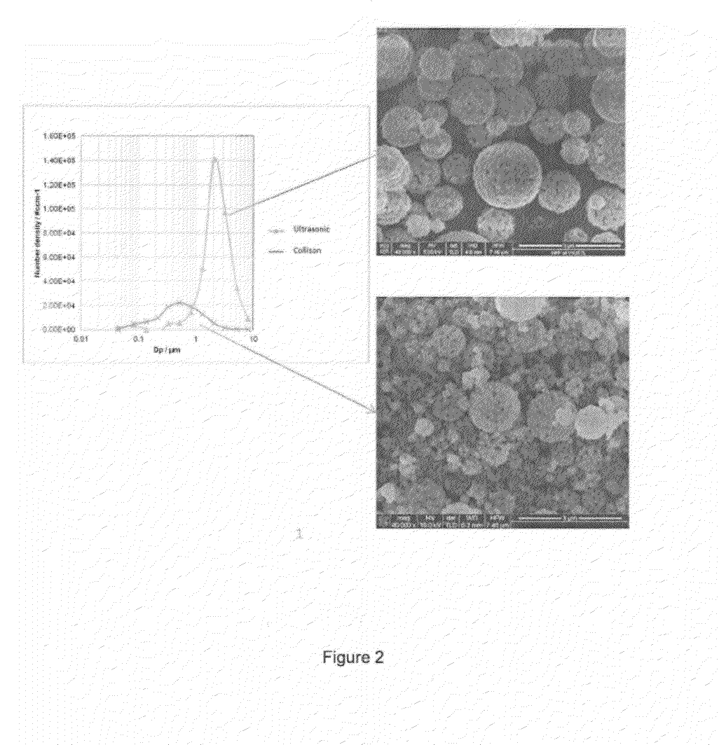

In particular, the process of the present invention may be used to produce a material comprising a plurality of secondary particles that comprise (are formed from agglomerated) metal oxide primary particles that comprise a lithium-containing metal oxide, wherein the primary particles have a maximum cross-section (along the direction of the greatest distance for each primary particle), which may also be referred to as the “size”, that is in the range of a about a nanometer to several micrometers and the secondary particles have a size that is in the range of a few nanometers to a few hundred micrometers. For example, the process may be controlled such that the size of the primary particles is in the range of about 1 nanometer to about 10 micrometers and the size of the secondary particles in the range of about 10 nm to about 100 μm (see, e.g., FIG. 2). Further, the process may be controlled such that the mean size of the primary particles is in the range of about 1 nm to about 500 nm and the mean size of the secondary particles is in the range of submicron (e.g., about 0.1 μm) to microns (e.g., 20 μm). In yet another embodiment, the mean size of the primary particles is in the range of about 500 nm to about 10 μm and the mean size of the secondary particles is in the range of about 1 μm to about 100 μm. Still further, the process may be controlled such that the standard deviation with respect to the median value for the secondary particle size is in the range about 0 to about 10.

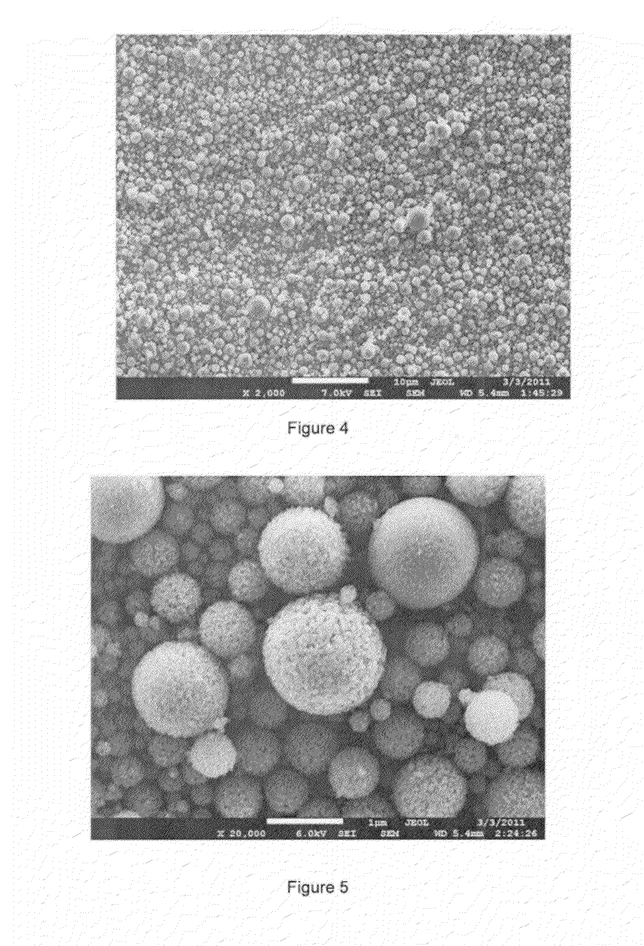

The process may also be controlled so that the secondary particles tend to be spherical (see, e.g., FIG. 4). In order of preference, more than 50%, 60%, 70%, 80%, 90%, 95%, or greater of the secondary particles are spherical. Further, the process of the present invention lends itself to producing spherical secondary particles that have a relatively high degree of sphericity (wherein the degree of sphericity is a comparison to a true sphere (i.e., a three-dimensional object having a volume= 4/3-πr³). A conventional measure of sphericity is provided by the following equation:

$$Ψ = \frac{π \frac{1}{3} {( 6 {V}_{p} )}^{\frac{2}{3}}}{{A}_{p}}$$

where Vₚ is volume of the particle and Aₚ is the surface area of the particle. Because the foregoing equation is based on surface area of a solid particle and the present particles are porous it is believed to not be a particular appropriate manner of determining sphericity. As such, the degree of sphericity (in terms of a ratio in which a sphere has a sphericity of 1) is determined by determining the maximum and minimum cross-sectional distances of a secondary particle and the difference between the two is divided by the maximum cross-sectional distance and this number is subtracted from 1 to yield the sphericity (sphericity=1−(csₘₐₓ−csₘᵢₙ/csₘₐₓ)). In particular, in one embodiment of the present invention the secondary particles have a sphericity of at least about 0.95. In another embodiment, the secondary particles have sphericity of at least about 0.98. In yet another embodiment, the secondary particles have a sphericity of at least about 0.99.

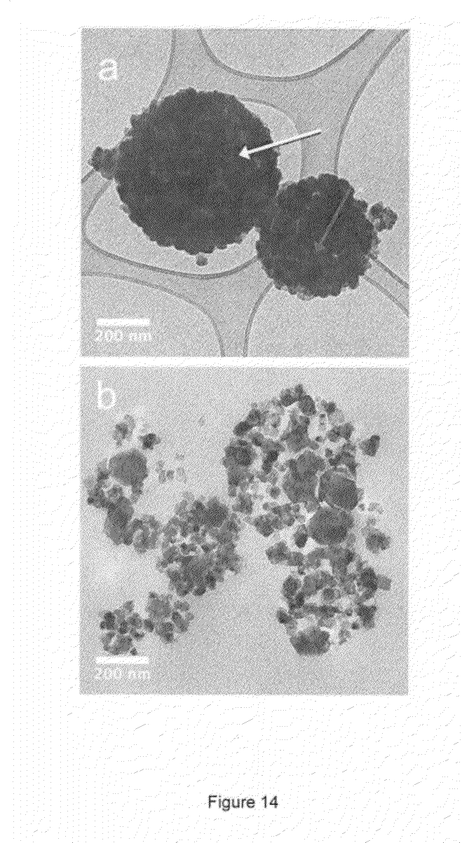

Additionally, the process of the present invention may be controlled so that individual secondary particles are highly porous (see, e.g., FIG. 5 and FIG. 7). This high level of porosity is also present in the interior of the secondary particles as shown in FIG. 14(b). The pore structures in the particles include nanopores (less than 2 nm), mesopores (between 2 nm and 50 nm), and macropores (above 50 nm). The interparticle pore spacing (the space between primary particles) is within the range of from few nanometers (e.g., 2 nm) to tens of nanometers (e.g., 100 nm) and the porosity is distributed uniformly within the particle. As such, these materials may referred to as being “mesoporous”. Without being bound to a particular theory, it is believed that this porous morphology may facilitate the interparticle transportation of lithium and, as a result, electrodes made from these mesoporous materials have the potential for achieving higher rate-capabilities than solid bulk materials. Brunnauer-Emmett-Teller surface area measurement can be applied to measure the porosity and surface area and materials of the present invention have been measured to have a specific surface area in the range of about 0.1 m²/g to about 100 m²/g. The mean size and size distribution of the secondary particle are believed to affect the packing density of the particles and this can affect the loading density of the cathode film. Furthermore, this will impact the amount of binder that is needed to attain proper adhesion. Typically, smaller particles with a relatively narrow size distribution tend to have a lower packing density and tend to require more binder. Unlike particles from co-precipitation, the particles produced from spray pyrolysis tend to be highly spherical even when produced at a commercial scale, and the size and size distribution may be selected or controlled by selecting or controlling the size and size distribution of the droplets.

### Metal Oxide

The positive electrode active materials of the present invention comprise lithium intercalating metal oxide compositions. More specifically, the material comprises lithium-containing metal oxide, which may be described according to the general chemical formula disclosed in U.S. Patent Application Publication No. 2009/0297947, Deng et al., entitled “Nano-sized Structured Layered Positive Electrode Materials to Enable High Energy Density and High Rate Capability Lithium Batteries”—Li_{1+α}(NiₓCo_{y}Mn_{z})₁₋ₜMₜO_{2-d}R_{d}, wherein M is selected from Al, Mg, Fe, Cu, Zn, Cr, Ag, Ca, Na, K, In, Ga, Ge, V, Mo, Nb, Si, Ti, Zr, or a mixture of any two or more thereof, R is selected from F, Cl, Br, I, H, S, N, or a mixture of any two or more thereof, and 0≦α≦0.50; 0<x≦1; 0≦y≦1; 0<z≦1; 0≦t≦1;and 0≦d≦0.5. In one embodiment, the range of a is increased to 0≦α≦1. In one embodiment, M is selected the group consisting of Al, Mg, Fe, Cu, Zn, Cr, Ag, Ca, Na, K, Si, Ti, V, and combinations thereof, and R is selected from the group consisting of F, Cl, Br, I, and combinations thereof. The fluorine was reported to be a dopant that can contribute to cycling stability. In another embodiment, t=0, y=0, and d=0 such that the foregoing formula is reduced to Li_{1+α}NiₓMn_{z}O₂, wherein 0≦α≦0.2, 0.1≦x≦0.6, and 0.2≦z≦0.6.

In some embodiments of the present invention the metal oxide compositions may have a composite crystal structure. Metal oxides with composite crystal structures may be represented by a two component chemical formula xLi₂MO₃.(1−x)LiM′O₂, wherein: M is one or more metallic ions having an average oxidation state of +4, and M′ is one or more metallic ions have an average oxidation state of +3, and 0<x<1. In an embodiment of the present invention, M is Mn and M′ is selected from the group consisting of Mn, Ni, Co, Cr, and combinations thereof. In another embodiment, M is Mn and M′ comprises at least one of Mn and Ni. In yet another embodiment, M is Mn and M′ is Mn and Ni. In yet another embodiment, M is Mn and M′ is Mn, Ni, and Co. Specific examples include xLi₂MnO₃.(1−x)LiMn_{0.5}Ni_{0.5}O₂, xLi₂MnO₃.(1−x)LiCoO₂, and xLi₂MnO₃.(1−x)LiMn_{1/3}Ni_{1/3}O₂. In further embodiments, for any of the foregoing formulas x may be in the following range 0.3≦x≦0.7.

The process of the present invention may be controlled so that it, along with the selection of the metal oxide composition, affects the crystalline structure of the metal oxides of the present invention. For example, the process may be controlled and the composition selected such that the metal oxide has a layered-layered composite crystalline structure. In fact, experimental results to date suggest that a metal oxide having a layered-layered structure has a desirable combination of capacity and cycleability. For example, Li[Li_{(1/3-2a/3)}NiₐMn_{(2/3-a/3)}]O₂ (0<a<½) synthesized at high temperature has delivered over 200 mAhg⁻¹ at a current density as high as 1/10C. The layered compounds are considered to be an integration of two layered materials Li₂MnO₃ (C2/m) and LiMn_{0.5}Ni_{0.5}O₂ (R 3̅m) forming a rock-salt-type α-NaFeO₂ structure with R 3̅m space group, which are often described as layered-layered integrated composites yLi₂MnO₃.(1−y)LiMn_{0.5}Ni_{0.5}O₂ (where 0≦y—1). The two chemical formulas are equivalent by the relationship: a=(1−y)/(1+2y).

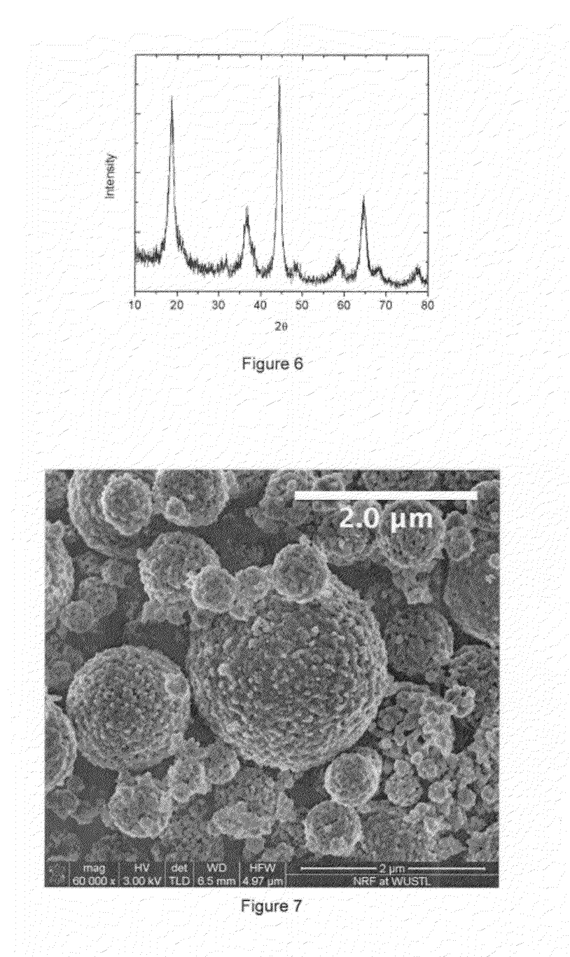

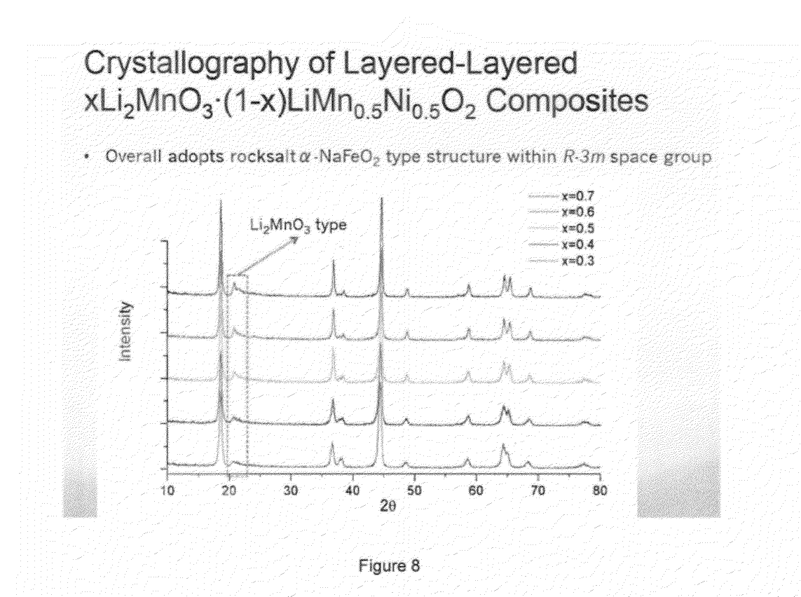

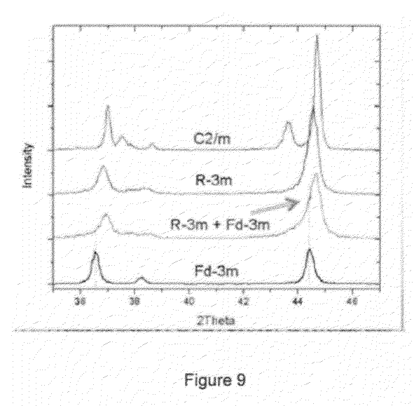

Alternatively, the process may be controlled and the composition selected such that the metal oxide has a layered-spinel composite crystalline structure. Li₂MnO₃ has a monoclinic crystal structure with C2/m space group. Li₂MnO₃ may be reformulated as layered Li[Li_{1/3}Mn_{2/3}]O₂, therefore, it may be structurally integrated into layered LiMn_{0.5}Ni_{0.5}O₂ (R 3̅m space group), forming layered “composite” materials. The XRD pattern of a 0.5Li₂MnO₃.0.5LiMn_{0.5}Ni_{0.5}O₂ (or Li_{1.2}Mn_{0.6}Ni_{0.2}O₂) powder formed via spray pyrolysis before being annealed is shown in FIG. 6, which is similar to a lithiated-LiCoO₂-type structure. Due to the nanocrystalline structure, the XRD peaks are very broad. It can be indexed as spinel-type (Fd 3̅m) structure or layered (R ^{3̅}m) structure. For reference, the XRD patterns of C2/m, R 3̅m, R 3̅m+Fd 3̅m, and Fd 3̅m are set forth in FIG. 9.

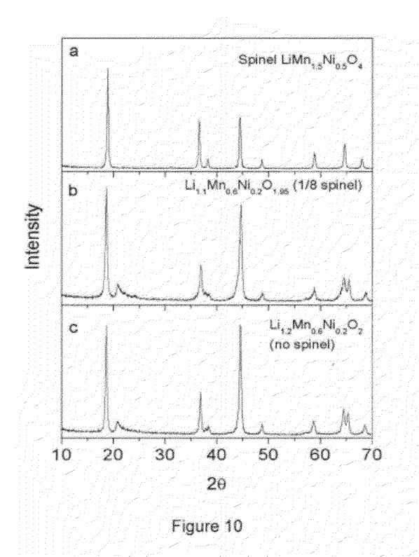

Layered 0.5Li₂MnO_{3.0.5}LiMn_{0.5}Ni_{0.5}O₂ has a simplified formula Li_{1.2}Mn_{0.6}Ni_{0.2}O₂ or Li_{1.5}Mn_{0.75}Ni_{0.25}O_{2.5}, wherein the ratio of Mn and Ni cations is 3:1. In a spinel LiMn_{1.5}Ni_{0.5}O₄ (Fd 3̅m space group), the ratio of Mn and Ni cations is also 3:1. Therefore, spinel LiMn_{1.5}Ni_{0.5}O₄ can be structurally integrated into layered 0.5Li₂MnO₃.0.5LiMn_{0.5}Ni_{0.5}O₂, forming an integrated layered-spinel type structure z [LiMn_{1.5}O_{0.5}O₄].(1−z)[Li₂MnO₃.LiMn_{0.5}Ni_{0.5}O₂]. For example, a material having the formula Li_{1.1}Mn_{0.6}Ni_{0.2}O_{1.95} has the layered-spinel structure. The amount of spinel type structure in 0.5Li₂MnO₃.0.5LiMn_{0.5}Ni_{0.5}O₂ can be varied from 0 to 100%. The transition from pure spinel LiMn_{1.5}Ni_{0.5}O₄ to pure layered Li_{1.2}Mn_{0.6}Ni_{0.2}O₂ is shown in the XRD analysis of FIG. 10. Experimental results to date indicate that metal oxides with a layered-spinel structure tend to be metastable and convert to a monoclinic C2/m structure if annealed at a relatively high temperature (e.g., at 800° C. for 2 hours). Further, experimental results to date indicate that metal oxides with a layered-spinel structure tend to have capacities below that of layered-layered composite metal oxides.

Alternatively, the process may be controlled and the composition selected such that the metal oxide has a low temperature LiCoO₂—(LT-LiCoO₂—) type crystal structure. Experimental results to date indicate that metal oxides with a LT-LiCoO₂-type crystal structure tend to have severe capacity fading as the cycles increase.

### Spray Pyrolysis

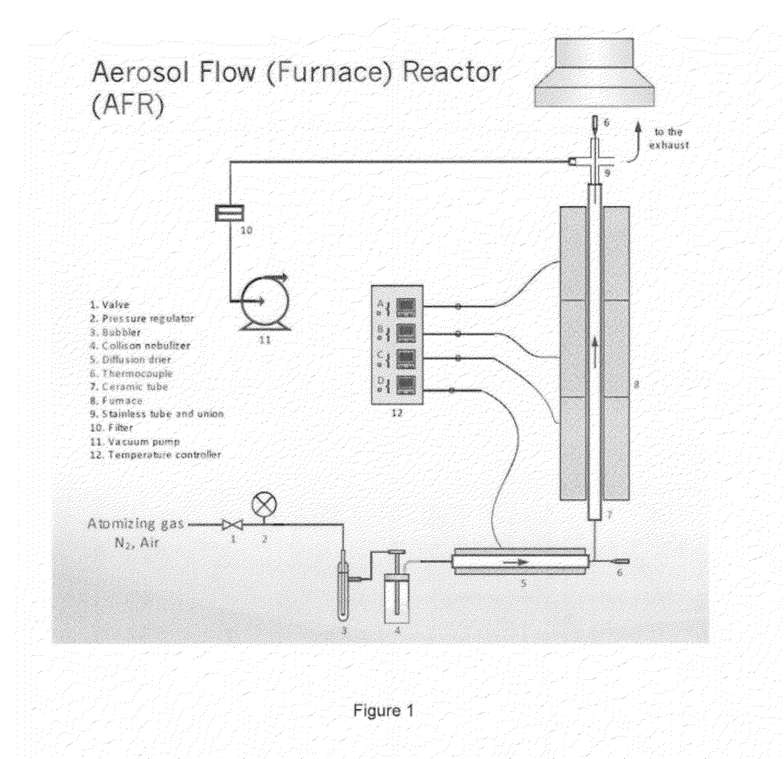

One embodiment of an apparatus for carrying out the spray pyrolysis method of the present invention is set forth in FIG. 1, which depicts a tubular aerosol flow reactor.

The process of the present invention involves performing spray pyrolysis using a solution comprising dissolved precursor compounds for supplying the elements of the metal oxides of the present invention. The precursor compounds may be selected from any appropriate materials. In one embodiment of the present invention, the precursor compounds are nitrates of the various metallic elements that are to be included in the metal oxide (e.g., lithium nitrate, manganese nitrate, nickel nitrate, cobalt nitrate, etc.). That said, other precursor compounds such as acetates of the metallic elements have also been found to be acceptable.

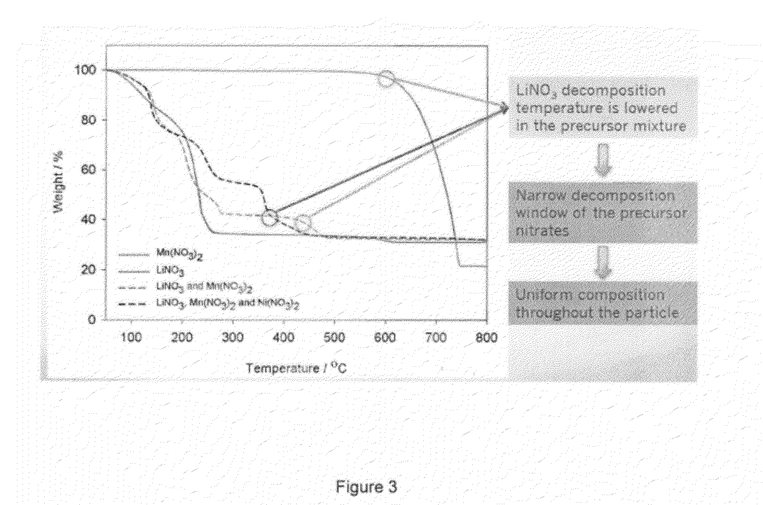

Advantageously, it has been found that forming a single precursor solution that is subjected to the spray pyrolysis process tends to result in the various precursor compounds decomposing at similar temperatures (e.g., within about 300° C. or even about 200° C. of each other) even when their decomposition temperatures, when heated individually, are dissimilar (e.g., greater than 300° C., 400° C., or even 500° C.), which can be significantly lower than the decomposition of a lone precursor compound.¹⁷ For example, it has been reported that pure Mn(NO₃)₂ decomposed into oxides in the temperature range of about 200 to about 280° C. and pure LiNO₃ began to decompose at about 600° C. and was fully decomposed by about 750° C. but when mixed together they both were completed decomposed at about 480° C. (more than 200° C. less than that of the pure LiNO₃). Thus, the assumed decomposition products were valid even for the mixture of nitrate precursors. Importantly, the decomposition temperature of LiNO₃ was much lowered in the mixture than alone. Without being held to a particular theory, it is believed that the lower decomposition of LiNO₃ achieved with the mixture is due to the presence of MnO₂ acting as a catalyst for the pyrolysis reactions.¹⁸ The decomposition temperature of LiNO₃ is further decreased when mixed with both Mn(NO₃)₂ and Ni(NO₃)₂ as shown in FIG. 3. Having a low and similar decomposition temperature for the precursors is believed to be advantageous when performing the process. In particular, obtaining complete decomposition at lower temperatures (in this case, less than 500° C.) allows for lower energy costs and if the precursors decompose at similar temperatures the stoichiometry of the metallic elements after decomposition tends to be similar to that of the mixture before decomposition. If this were not the case, segregation may occur thereby decreasing the uniformity and stoichiometry of the composition.

The aqueous precursor solution temperature can be from 0° C. to 100° C. under 1 atm pressure or a few atmospheres. The concentration of the metal salts in the precursor solution can range from 0 mole/L to 10 mole/L and can be varied depending on the solubility of the salt selected. In one embodiment of the present invention, the nitrates are dissolved in deionized/ultra-pure water at a certain ratio to match the stoichiometry in the Li_{1+α}(NiₓCo_{y}Mn_{z})₁₋ₜMₜO_{2-d}R_{d}. For example, for the synthesis of Li_{1.2}Mn_{0.6}Ni_{0.2}O₂ powders, the concentrations of LiNO₃, Mn(NO₃)₂ and Ni(NO₃)₂ (or in the corresponding crystal hydrate form) are 3 mole/L, 1.5 mole/L and 0.5 mole/L, which is prepared at room temperature, 23° C.

The spray pyrolysis process comprises aerosolizing the precursor solution to form fine precursor solution droplets in the micron-size range (e.g., 0.1 μm to 1000 μm). Solid (non-hollow) spherical particles may be formed from spray pyrolysis by selecting appropriate precursor(s), solvent(s), drying rate(s) and droplet size(s). If the droplets are sufficiently large such that the size of the calcined particles is in the range of about 5 to about 10 μm, the particles tend to become semi-spherical in shape, although they are still highly porous. Additionally, if the droplets are too large and/or the drying is too fast, the calcined particles tend to become hollow rather than uniformly porous. Such irregular shaped particles may be avoided by drying the droplets slowly or by appropriate choice of solvent wherein the precursors are more soluble. Also, irregular shaped particles may be avoided by removing overly large droplets from the stream before they are subjected to drying by including an appropriate device in the apparatus such as a cyclone or an impactor. Furthermore, excessively small droplets may be removed by a diffusion battery or some other appropriate device or structure. Of course, it is always possible to segregate overly large secondary particles after they are formed. The precursor solution may be aerosolized using any appropriate device or combination of devices such a gas-assisted nebulizer, an atomizer, an ultrasonic nebulizer, ultrasonic spray, rotating mesh, pressurized spray and air atomizing spray operated as necessary to achieve droplets of the size set forth above. Furthermore, more than one aerosolizer may be employed in series to broaden and tailor the size distribution of the incoming droplets. By way of example, when using a nebulizer in the apparatus set forth in FIG. 1, it has been found that the gas can be air, oxygen, nitrogen, or combination thereof, flowed at a rate that is within the range of about 1 to about 10 liters per minute, and the upper stream pressure may be selected to be within the range of about 20 to about 100 psi. Typically, the gas was air, and the flow rate was maintained at 3.3 liters per minute (lpm). In another example, a SONAER ultrasonic nebulizer was operated at between zero and full and at a gas flow rate of 1 to 50 lpm. Typically, the nebulizer was operated at full power, the gas was air, and the flow rate was maintained at 6 lpm.

The droplets are then dried to evaporate the solvent. It has been discovered that it is preferable for the drying to be accomplished by increasing the temperature of the droplets to what is believed to be a temperature that is around the boiling point of the solvent. Without being held to a particular theory, it is believed that if the drying operation heats the particles too quickly, the particle size and the particle morphology can be negatively impacted. Any appropriate device may be used to dry the droplets. For example, a preheater as described in the Examples, below, may used. For example, the outer wall temperature of the preheater may be varied within the range of room temperature to about 400° C. and the gas temperature in the preheater may be from room temperature to about 400° C. Alternatively, a diffusion-drier or spray drier may be used instead of the preheater as depicted in FIG. 1.

The dried particles are heat treated to decompose the precursor compounds and form nanostructured lithium transition metal oxide material (powder) comprised of a plurality of submicron- to micron-sized secondary particles that comprise nanosized primary particles that comprise the metal oxide. In general, the results to date suggest that it is preferable for the heat treatment to be sufficient to partially or completely decompose the precursor compounds and preferably the compounds are selected and/or mixed so that the precursor compounds decompose nearly simultaneously, which tends to ensure a uniform particle composition. Using a nitrate precursor solution, the furnace tube in FIG. 1 was maintained at between 400° C. and 700° C. The apparatus of FIG. 1 depicts separate drying and calcining devices but other set ups are equally applicable such as a single tube furnace with temperature zones for drying and calcining. Typically, the precursors are completely decomposed (i.e., the calcination is complete) at a time in the range of about milliseconds to about seconds. The calcined particles may be collected by for example using a filter.

The temperature of the furnace and residence time of the furnace may controlled to affect not just the extent of pyrolysis but also other properties of the powder, such as tapped density. Without being bound to a particular theory, it is believed that at a low enough temperature that pyrolysis is incomplete and some aggregation of the particles occurs, which affects the extent of agglomeration after annealing.

The calcined particles may be subjected to an annealing heat treatment to cause crystallite growth and affect the crystal structure of the metal oxide. For example, for the Li_{1.2}Mn_{0.6}Ni_{0.2}O₂ powder depicted in FIG. 7, after annealing at 800° C. for 2 hours, the grain size increased and the spherical shape of the secondary particles was preserved; the particle appears to be more porous after being calcined but before being annealed as depicted in FIG. 5. In general, as the annealing temperature is increased the crystallite size tends to grow more rapidly and, at sufficiently high temperature, the porosity of secondary particles tends to decrease. As such, it has been discovered that the annealing temperature is preferably no greater than about 1200° C. for these materials. Conversely, if the annealing temperature is too low (e.g., less than about 300° C.), there is insufficient mobility of the atoms in the metal oxide such that no significant crystallite growth occurs. As would be expected, the duration of the annealing heat treatment tends to increase with decreasing temperatures and vice versa. In view of the foregoing temperatures, the duration may be in the range from about 30 minutes to about 48 hours. Typically, the temperature is in the range of about 700 to about 900° C. and the duration is in the range of about 2 to about 20 hours. The annealing process may be carried out in air, N₂, O₂, Ar, He, or any combination of them at different ratios. By way of example, a Li_{1.2}Mn_{0.6}Ni_{0.2}O₂ powder remained porous after 10 hours of heat treatment at 800° C. Upon completion of the annealing, it is preferred that the particles be cooled slowly (e.g., about 3° C./minute) to help reduce the likelihood of forming metastable structures or defects in the metal oxide.

### Battery

A battery is commonly comprised of a negative electrode, a positive electrode, electrolyte in contact with the electrodes to provide ionic conductivity through the separator between electrodes of opposite polarity, and a separator between negative electrode and positive electrode, wherein the separator is electronically insulating while providing for at least selected ion conduction between the two electrodes. A variety of materials can be used as separators. For example, glass fibers formed into a porous mat can be used as a separator. Commercial separator materials are generally formed from polymers, such as polyethylene and/or polypropylene that are porous sheets that provide for ionic conduction. Commercial polymer separators include, for example, the CELGARD line of separator material from Hoechst Celanese, Charlotte, N.C. Further, a battery generally comprises current collectors associated respectively with the negative electrode and positive electrode to facilitate the flow of electrons between the electrode and an exterior circuit. The current collector may comprise metal, such as a metal foil or a metal grid. Typical metals include nickel, aluminum, stainless steel, and copper. A battery may comprise multiple positive electrodes and multiple negative electrodes, such as in a stack, with appropriately placed separators.

The positive electrode active compositions and negative electrode active compositions are generally powder compositions that are held together in the corresponding electrode with a polymer binder. Suitable polymer binders include, for example, polyvinylidine fluoride, polyethylene oxide, polyethylene, polypropylene, polytetrafluoroethylene, polyacrylates, ethylene-(propylene-diene monomer) copolymer (EPDM) and mixtures and copolymers thereof. The active-particle loading in the binder may be large, such as greater than about 80 weight percent.

The positive electrode composition, and possibly the negative electrode composition, may also comprise an electrically conductive powder distinct from the electroactive composition. Generally, a positive electrode may comprise from about 1 weight percent to about 25 weight percent distinct electrically conductive powder.

To form the electrode, the powders may be blended with a polymer in a suitable liquid, such as a solvent for the polymer. A film may be formed on the metal current collector from this mixture using the doctor-blade method or any other appropriate method. Calendering may be performed to improve the adhesion of the cathode film to the current collector. After drying (to remove the solvent), the resulting cathode (positive electrode) thin film may be punched out forming small cathode discs, for example, for coin cell electrodes.

Electrolytes for lithium ion batteries may comprise one or more lithium salts that generally have inert anions. Examples include lithium hexafluorophosphate, lithium hexafluoroarsenate, lithium bis(trifluoromethyl sulfonyl imide), lithium trifluoromethane sulfonate, lithium tris(trifluoromethyl sulfonyl)methide, lithium tetrafluoroborate, lithium perchlorate, lithium tetrachloroaluminate, lithium chloride and combinations thereof. Usually, the concentration of electrolyte is 1 M of the lithium salts and the solvent is a non-aqueous liquid that is inert and does not dissolve the electroactive materials. Exemplary solvents include propylene carbonate, dimethyl carbonate, diethyl carbonate, 2-methyl tetrahydrofuran, dioxolane, tetrahydrofuran, methyl ethyl carbonate, gamma-butyrolactone, dimethyl sulfoxide, acetonitrile, formamide, dimethyl formamide, triglyme (tri(ethylene glycol)dimethyl ether), diglyme (diethylene glycol dimethyl ether), DME (glyme or 1,2-dimethyloxyethane or ethylene glycol dimethyl ether), nitromethane, and mixtures thereof.

The present invention as generally described above, may be better understood in view of the following examples, which are provided for illustration and are not intended to limit the scope of the present invention.

### EXAMPLES

### Example 1

### General Procedures

The above-described spray pyrolysis method was performed with the apparatus of FIG. 1 to produce Li-rich Li_{(1.2-δ)}Mn_{0.6}Ni_{0.2}O_{(2-δ/2)} (0≦δ≦ 1/10) composite materials. The precursor solution was prepared by dissolving LiNO₃, Mn(NO₃)₂.4H₂O and Ni(NO₃)₂.6H₂O at a ratio of (1.2−δ):0.6:0.2 in deionized water. The total molar concentrations of Mn(NO₃)₂.4H₂O and Ni(NO₃)₂.6H₂O were maintained at 2 M. The corresponding Li concentration was calculated based on the δ values in Li(_{1.2-δ)}Mn_{0.6}Ni_{0.2}O_{(2-δ/2)} composites. For example, for δ=0, the composite is Li_{1.2}Mn_{0.6}Ni_{0.2}O₂, and the precursor solution contained 1.5 M Mn, 0.5 M Ni, and 3 M Li cations.

The precursor solutions were aerosolized with air-assisted nebulizers (or atomizer or sprayer). Specifically, a one-jet collision nebulizer from BGI Inc. was used to aerosolize the precursor solution to form fine precursor droplets in the micron-size range. The atomizing gas was air flowing at 3.3 liters per minute with the upper stream pressure of the atomizer being about 40 psi. After aerosolization, the precursor aerosols flowed into a preheater maintained at about 400° C. (wall temperature) and then a vertical ceramic tube furnace (1 inch OD, ¾ inch ID, 3 ft. long). At the preheater outlet, the gas temperature was measured to be within the range of about 100 to about 150° C. and, therefore, it is believed that no decomposition occurred during water evaporation in the preheater. The wall temperature of the tube furnace was kept at about 700° C. using three independent temperature controllers. Downstream of the reactor, the produced powders were collected with a membrane filter. The collected powders were annealed at about 700° C. or about 800° C. for about two hours followed by slow cooling at a rate of about 3° C./min. To differentiate the different powders herein, the annealing temperature will be shown in parentheses after the material formula.

### Compositional Evaluation

Thermogravimetric analysis (TGA) was performed on the precursor nitrate salts LiNO₃, Mn(NO₃)₂.4H₂O, and Ni(NO₃)₂.6H₂O prior preparation of the precursor aqueous solutions. By analyzing the weight loss of the nitrate salts, the mass concentration of each metal element (Li, Mn and Ni) was validated in the precursor salt. Inductively-coupled-plasma mass spectrometry (ICP-MS, Agilent 7500 ce) was also performed to confirm the elemental composition of the precursors and the powders. Table 1 shows that the stoichiometry of the precursor is almost identical to the theoretical stoichiometry of the powder. Because the heat treatment of the powders did not exceed about 800° C., it is assumed that any loss of lithium by evaporation was negligible and that the stoichiometry was preserved after heat-treatment.

TABLE 1
ICP-MS results of the precursor solution and the theoretical charge/discharge capacities

| | | | | Charge | Discharge | Coulombic |
|---|---|---|---|---|---|---|
| | Measure stoichiometry | | | Capacity | Capacity | efficiency |
| Theoretical Stoichiometry | Li | Mn* | Ni | (mAhg⁻¹) | (mAhg⁻¹) | (%) |
| Li_{1.1}Mn_{0.6}Ni_{0.2}O_{1.95} | 1.121 ± 0.011 | 0.60 | 0.214 ± 0.005 | 352.9 | 240.6 | 68.2 |
| (Li_{1.50}Mn_{0.75}Ni_{0.25}O_{2.50}) | | | | | | |
| Li_{1.15}Mn_{0.6}Ni_{0.2}O_{1.975} | 1.17 ± 0.005 | 0.60 | 0.214 ± 0.005 | 365.7 | 246.4 | 67.4 |
| (Li_{1.44}Mn_{0.75}Ni_{0.25}O_{2.469}) | | | | | | |
| Li_{1.2}Mn_{0.6}Ni_{0.2}O₂ | 1.219 ± 0.008 | 0.60 | 0.212 ± 0.006 | 378.2 | 252.2 | 66.7 |
| (Li_{1.375}Mn_{0.75}Ni_{0.25}O_{2.4375}) | | | | | | |

*The stoichiometry of Mn is fixed at 0.6, and the stoichiometries of Li and Ni are calculated based on ICP-MS data.

### Crystallographic Evaluation

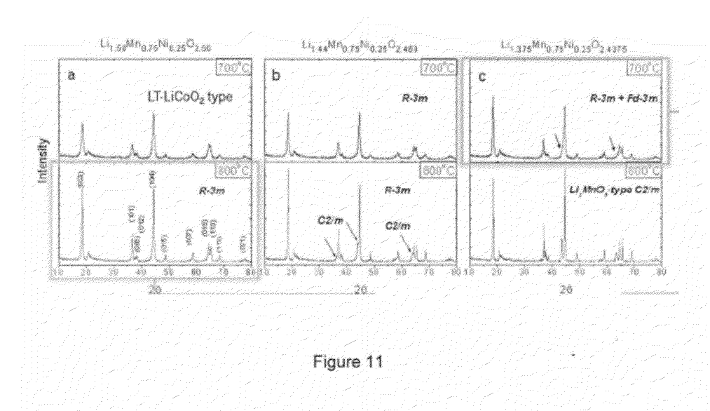

X-ray powder diffraction data was obtained with a Rigaku Diffractometer (Geigerflex D-MAX/A) using Cu—Kα radiation and operated at 35 kV and 35 mA. The scanning range was from 10° to 80° 2θ with a step size of 0.04°s⁻¹. FIG. 11 shows XRD patterns of Li_{(1.2-δ)}Mn_{0.6}Ni_{0.2}O_{(2-δ/2)} (δ=0, 1/20, 1/10) after the annealing at 700° C. and 800° C. Each of the XRD patterns shows a broad peak between 20° and 25°, which has been reported to indicate superlattice ordering of Li, Mn, and Ni cations in transition-metal layer (3a sites).^{1.9} The XRD peaks of the powders annealed at 800° C. powders are sharper, which is believed to be indicative of a larger grain size.

The Li_{1.2}Mn_{0.6}Ni_{0.2}O₂ (800° C.) shows a nearly identical XRD pattern to the Li_{1.1}Mn_{0.6}Ni_{0.2}O_{1.95} (700° C.), and the pattern may be indexed to α-NaFeO₂-type structure with R 3̅m space group. The Li_{1.2}Mn_{0.6}Ni_{0.2}O₂ (700° C.) shows a single peak near 65° 2θ, which may suggest that it is adopting a different crystal structure other than R 3̅m. An identical XRD spectrum has been reported for Li[Li_{(1/3-2a/3)}NiₐMn_{(2/3-a/3)}]O₂ with high Ni concentrations (i.e., x≦⅓), when heated between about 600° C. and about 900° C.^{2,10} It was also reported that the structure of that material is isostructural to lithiated-LiCoO₂ (LT-LiCoO₂) with a spinel-type Fd 3̅m structure due to exchange/mixing of Li and Ni cations in the 16c and 16d sites.^{2,10} In view of the foregoing, it is believed that decreasing the Li concentration in the material may reduce the exchange/mixing effect. This belief is corroborated by the upper XRD patterns in FIG. 11(b) and FIG. 11(c), which indicate that the Li_{1.15}Mn_{0.6}Ni_{0.2}O_{1.975} (700° C.) and Li_{1.1}Mn_{0.6}Ni_{0.2}O_{1.95} (700° C.) have predominantly a R 3̅m structure.

Certain peaks in the XRD spectrum of Li_{1.1}Mn_{0.6}Ni_{0.2}O_{1.95} (700° C.) are broadened at smaller angles near 36°, 44° and 65° 2θ, as indicated by the arrows in FIG. 11(c). This broadening is not observed for the layered R 3̅m Li_{1.2}Mn_{0.6}Ni_{0.2}O₂(800° C.). The peak broadening is similar to a previously reported observation for an integrated layered-spinel structure synthesized via coprecipitation with post-lithiation.⁸ It has also been suggested that the spinel structure (Fd 3̅m) and the layered structure (R 3̅m) are structurally compatible and can mix physically at the atomic level forming an integrated composite.^{5,6,8} The similarity of the XRD patterns produced from spray pyrolysis suggests that the Li_{1.1}Mn_{0.6}Ni_{0.2}O_{1.95} (700° C.) may also have an integrated layered-spinel structure.

At a higher annealing temperature, Li_{1.15}Mn_{0.6}Ni_{0.2}O_{1.975} (800° C.) and Li_{1.1}Mn_{0.6}Ni_{0.2}O_{1.95} (800° C.) both undergo a phase transition from α-NaFeO₂ type structure (R 3̅m) to monoclinic Li₂MnO₃-type structure (C2/m).⁷ The observed monoclinic Li₂MnO₃-type structure was also detected in Li₍₁₊ₓ₎Mn_{0.75}Ni_{0.25}O_{(2.25+x/2)} (where x=0, ¼) prepared via coprecipitation of mixed metal oxide precursors.⁷ The R 3̅m phase and Li₂MnO₃-type phase may coexist in the material due to extensive overlapping of XRD peaks. There is no indication, however, that the transformation occurs for Li_{1.2}Mn_{0.6}Ni_{0.2}O₂ (800° C.) heated at the same temperature. With only a 4% decrease in total Li, the transformation tends towards the more thermodynamically stable structure.

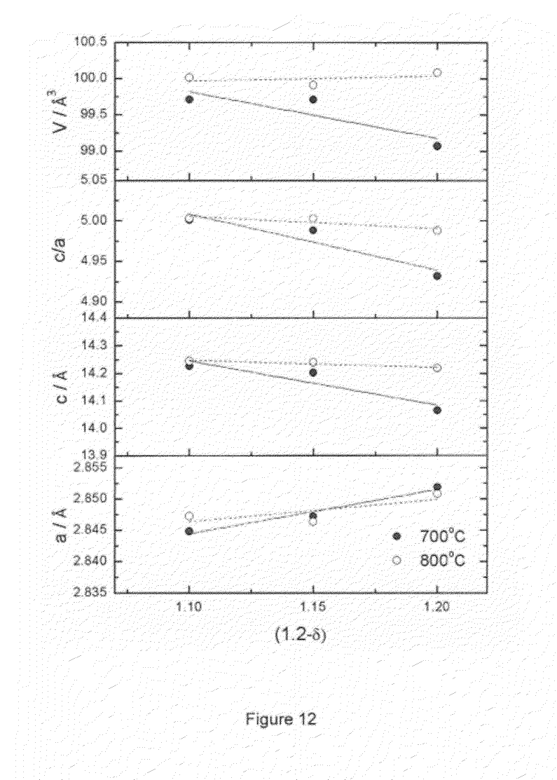

Cell refinement using the Whole-Pattern-Fitting method (WPF) of the JADE 9 software was applied to estimate the lattice parameters of the powders for the most predominated phase with R 3̅m symmetry. In the refinement, it was assumed that the R 3̅m structure still dominates in Li_{1.1}Mn_{0.6}Ni_{0.2}O_{1.95} (800° C.), as the XRD peaks of the R 3̅m structure can overlap with that of the Li₂MnO₃-type structure with C2/m symmetry. As seen in FIG. 12, the lattice constant c, the c/a ratio, and the unit cell volume decrease roughly linearly with Li content, while lattice constant, a, increases. The decrease in the c/a ratio and unit cell volume is consistent with the formation of the spinel-type structure for Li_{1.1}Mn_{0.6}Ni_{0.2}O_{1.95} (700° C.). At an annealing temperature of 800° C., the lattice constant c, the c/a ratio, and the unit cell volume of the powders are almost independent of the different Li-contents as seen by the open circles in FIG. 12. Li_{1.2}Mn_{0.6}Ni_{0.2}O₂ (800° C.) and Li_{1.1}Mn_{0.6}Ni_{0.2}O_{1.95}(700° C.) both adopt a R 3̅m structure and show almost identical lattice constants c and unit cell volumes.

### Morphology Evaluation

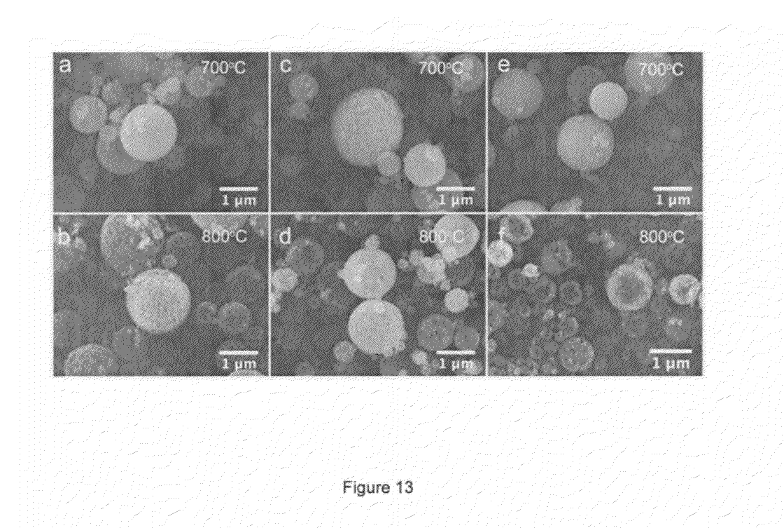

The morphologies of the different powder particles were evaluated with a scanning electron microscope (SEM, JEOL 7001LVF) and transmission electron microscope (TEM, FEI Tecnai G2 Spirit and JEOL 2100F). FIG. 13 and FIG. 14 are images from the SEM and TEM evaluation, respectively. The powders have a morphology that is not uncommon for powders produced by spray pyrolysis: they are spherical in shape, polycrystalline, and solid internally (i.e., not hollow). Annealing at 700° C. preserved the shape and morphology of the as-synthesized powders. Annealing at 800° C., however, caused the powders to undergo different degrees of sintering and coarsening. The Li_{1.2}Mn_{0.6}Ni_{0.2}O₂ (800° C.) powder retained a porous structure with nano-sized primary particles as shown in FIG. 13(b). In contrast, the Li_{1.1}Mn_{0.6}Ni_{0.2}O_{1.96} (800° C.) powder coarsened and the particle surface appears more faceted than that of the other powders as shown in FIG. 13(f). This suggests that the Li content in the powder can significantly affect the sintering temperature, and consequently the powder morphology.

Porosity is widely considered important to improve the rate performance of high-energy cathode materials. As such, Li_{1.2}Mn_{0.6}Ni_{0.2}O₂ (800° C.) is particularly attractive due to the well-defined crystal structure and superior porous morphology as shown in FIG. 13. The TEM morphology of Li_{1.2}Mn_{0.6}Ni_{0.2}O₂ (800° C.) particles shown in FIG. 14(a) indicates a “solid” (i.e., non-hollow) internal structure and nano-sized primary particles. The primary particles are within the range of about 20 to about 100 nm in size. Nano-scale tunnels are also observed, indicating an open pore structure throughout the particle.

An ultramicrotome (Leica EM UC7) was applied to section the particle to obtain the morphology of the internal structure of the particle. The microtome result shown in FIG. 14(b) reveals that the inner-particle is highly porous. The interparticle pore spacing varies from few nanometers to tens of nanometers in size and is distributed uniformly within the particle. Without being bound to a particular theory, it is believed that this porous morphology may facilitate the interparticle transportation of lithium and, as a result, electrodes made from these mesoporous materials have the potential for achieving higher rate-capabilities than solid bulk materials.

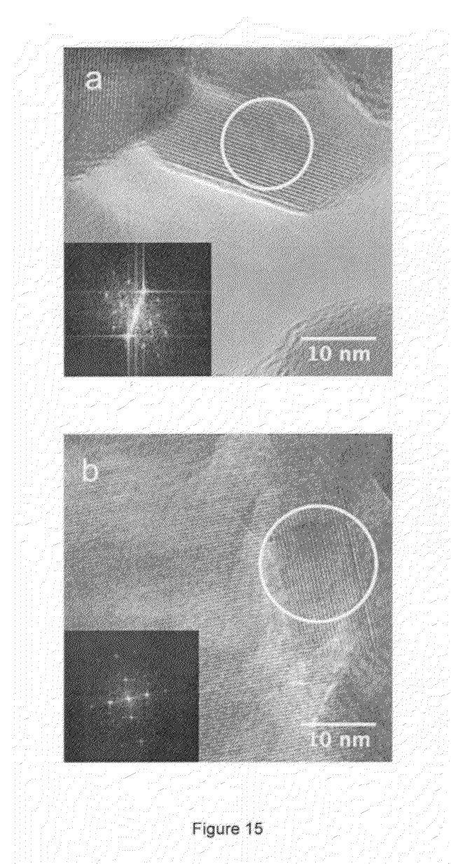

The microstructure of Li_{1.2}Mn_{0.6}Ni_{0.2}O₂ (800° C.) and Li_{1.1}Mn_{0.6}Ni_{0.2}O_{1.95} (700° C.) were studied by high-resolution TEM (HR-TEM). As shown in FIG. 15, the former has a typical layered R 3̅m structure. The measured interplanar spacing is 4.76±0.18 Å along the (001) plane. There are, however, some “non-layered” fringes in the 5˜10 nm domain that are structurally integrated with the layered structures as shown in FIG. 15(a). The “non-layered” fringes possibly arise from a monoclinic Li₂MnO₃ phase because Li_{1.2}Mn_{0.6}Ni_{0.2}O₂ may be considered to be a Li₂MnO₃—LiMn_{0.5}Ni_{0.5}O₂ integrated structure. To identify the monoclinic phase, Fourier transform of the portion of the fringe structure on the HR-TEM image was applied, which can represent the diffraction pattern of the crystal structures. Fourier transform of the HR-TEM image of Li_{1.2}Mn_{0.6}Ni_{0.2}O₂ (800° C.) has clear reflections from both rhombohedral R 3̅m and monoclinic phases as shown in the inserted image in FIG. 15(a).¹¹ Therefore, it can be concluded that nano domains of R 3̅m and monoclinic phases are present and integrated in the Li_{1.2}Mn_{0.6}Ni_{0.2}O₂ powders. The HR-TEM image of Li_{1.1}Mn_{0.6}Ni_{0.2}O_{1.95} (700° C.) shown in FIG. 15(b) also reveals that the nano domain of “non-layered” structures (5˜10 nm) is structurally integrated with the layered structure. Fourier transform of the selected area shows great similarity to the electron diffraction pattern of the spinel LiMn₂O₄ as shown in FIG. 15(b).¹² This observation is consistent with the XRD of FIG. 11(c) that shows some peak broadening towards lower 2θ degrees (see arrows). Therefore, the Li_{1.1}Mn_{0.6}Ni_{0.2}O_{1.95} (700° C.) material is believed to have a layered-spinel integrated structure. The measured interplanar spacing is 4.72±0.07 Å along the (001) planes, identical to the (111) inter-reticular distance of the spinel LiMn₂O₄.¹² The decrease in interplanar spacing for Li_{1.1}Mn_{0.6}Ni_{0.2}O_{1.95} (700° C.) is expected to be due to the lower occupancy of Li between the two consecutive layers. In summary, the microstructure analysis indicates that the integrated layered-spinel structure may exist in Li-deficient powders synthesized via spray pyrolysis with mixed nitrate precursors.

### Evaluation of Electrochemical Performance

The electrochemical performance of the Li_{(1.2-δ)}Mn_{0.6}Ni_{0.2}O_{(2-δ/2)} (0≦δ≦ 1/10) powders was evaluated using 2032 coin-type half cells (Hohsen Corporation). To prepare the cathode, the active material, a polyvinylidene fluoride (PVdF) binder, and Super-P conductive carbon black were blended at a ratio of about 80:10:10 by mass, suspended in N-methyl-2-pyrrolidene (NMP), and homogenized to form a slurry. The slurry was then cast on aluminum foil using the doctor blade technique to form a thin cathode film. The cathode film was dried in a vacuum oven at about 130° C. overnight, forming a dry film about 30 to 50 μm thick. For finer powders, adhesion can be a challenge and to ensure good adhesion more active binder may be used. This, however, reduces the amount of active material and is typically considered to be undesirable. It has been found that the adhesion of these powders may be improved without increasing binder by roughening the surface of the metal current collector before applying the film and by ensuring that after the film is dried that it be heated under vacuum overnight. For example, for PVdF good adherence has been observed when heated to between 120-130° C. under vacuum for about 8-12 hours.

The cathode was slightly calendered to improve the adhesion. Small, round, cathode discs having a diameter of about 13 mm were punched out of the dry film for the 2032 coin-type test cells. Pure lithium foil (the anode) and the prepared cathode disc were separated by a 2500 CELGARD membrane (Celgard LLC). The electrolyte was 1M LiPF₆ in an ethylene carbonate/diethyl carbonate/dimethyl carbonate solution (EC:DEC:DMC=1:1:1 by volume). The test cells were assembled in an argon-filled glove box. All the electrochemical tests were performed at room temperature (about 23° C.).

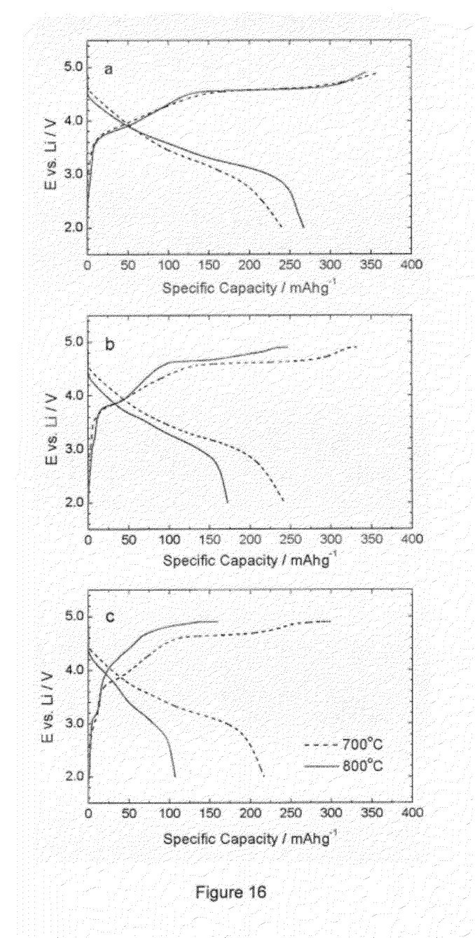

The electrochemical properties of all six powders were tested with coin cells. FIG. 16 shows the initial charge/discharge between 2.0 and 4.9 V at a current density of 11.5 mAg⁻¹. The CCCV (Constant-Current, Constant-Voltage) charging procedure applies for all the test cells. For the powders annealed at 700° C., all three materials show a predominantly two-staged charge profile, except for the small deviation near 3 V for Li_{1.1}Mn_{0.6}Ni_{0.2}O_{1.95}, and a very smooth discharge profile, as is shown by the dash lines in FIG. 16. During the initial charge, the voltage slowly climbed from 3.5 V to 4.5 V owing to the Ni²⁺/Ni⁴⁺ redox couple and at about 4.5 V a voltage plateau was observed, which is attributed to the removal of Li₂O from Li₂MnO₃.^{3,13} The charge capacity increased with increasing initial Li content as expected simply because more Li can be extracted from the electrodes.

The Li_{1.2}Mn_{0.6}Ni_{0.2}O₂ composite material may be recharacterized as 0.5Li₂MnO₃.0.5LiMn_{0.5}Ni_{9.5}O₂ having two equal, compatible “layered-layered” structures. As noted in Table 1, the theoretical charge capacity for Li_{1.2}Mn_{0.6}Ni_{0.2}O₂ is calculated to be 378 mAhg⁻¹ and is based on the assumption that all of the Li is extracted from the host materials following the method of Johnson et al.^{3,13} The ideal composition of a fully charged electrode can be written as Mn_{0.75}Ni_{0.25}O₂, wherein both Mn and Ni are tetravalent (Mn⁴⁺, Ni⁴⁺).³ The theoretical discharge capacity is 252 mAhg⁻¹, of which 126 mAhg⁻¹ is attributed to the Ni⁴⁺/Ni²⁺ redox couple and the other 126 mAhg⁻¹ is attributed to the Mn⁴⁺/Mn³⁺ redox couple. Based on the above calculations, the theoretical coulombic efficiency is about 67% for the first cycle. The experimental results show that at a constant current density of 11.5 mAg⁻¹ (about 1/20 C), Li_{1.2}Mn_{0.6}Ni_{0.2}O₂ (700° C.) and Li_{1.2}Mn_{0.6}Ni_{0.2}O₂ (800° C.) have an initial charge capacity of about 360 mAhg⁻¹ and about 343 mAhg⁻¹, respectively. The former is almost identical to the theoretical charge capacity. The lower initial charge capacity of Li_{1.2}Mn_{0.6}Ni_{0.2}O₂ (800° C.) is possibly due to incomplete-activation at this current density, which may be because of the closed-packed crystal structure. As noted above, Li_{1.2}Mn_{0.6}Ni_{0.2}O₂ (700° C.) shows a “spinel-type” LT-LiCoO₂ structure. Thus, the transportation of Li is kinetically favored so that all of the Li may be extracted with a deep charge at this current density. The discharge capacity for LT-LiCoO₂-type Li_{1.2}Mn_{0.6}Ni_{0.2}O₂ (700° C.) is 240 mAhg⁻¹ with a coulombic efficiency of 67%, also identical to the calculated theoretical value. The layered Li_{1.2}Mn_{0.6}Ni_{0.2}O₂ (800° C.) shows an anomalous discharge capacity of 266 mAhg⁻¹, with a higher coulombic efficiency of 78%. The discharge capacity is also higher than its theoretical value. The reason for the excess capacity of this material has not been fully explained yet, but several hypotheses have been proposed in the literature (e.g., surface/electrolyte reactions and capacitive effects).^{4,13}

Li_{1.15}Mn_{0.6}Ni_{0.2}O_{1.975} and Li_{1.1}Mn_{0.6}Ni_{0.2}O_{1.95} are designed to have the layered-spinel integrated structure and can be characterized as 1/16[LiMn_{1.5}Ni_{0.5}O₄]. 15/16[Li₂MnO₃.LiMn_{0.5}Ni_{0.5}O₂] and ⅛[LiMn_{1.5}Ni_{0.5}O₄].⅞[Li₂Mn_{0.3}.LiMn_{0.5}Ni_{0.5}O₂], respectively. That said, their actual structures may be more complex and different from the ideal structure following heat treatment. The charge profiles of Li_{1.1}Mn_{0.6}Ni_{0.2}O_{1.95} (both 700° C. and 800° C.) electrodes have a small capacity near 3 V as shown in FIG. 16(c), indicating the presence of Mn³⁺.⁷ The 3 V region tends to decrease for electrodes with higher Li-content and is absent in Li_{1.2}Mn_{0.6}Ni_{0.2}O₂. The 3 V region is considered to be evidence for the presence of spinel LiMn_{1.5}Ni_{0.5}O₄.⁸ Therefore, the charge voltage profile also confirms the presence of spinel structure in Li_{1.1}Mn_{0.6}Ni_{0.2}O_{1.95}(700° C.), consistent with the XRD and HR-TEM results.

As seen in FIG. 16(b) and FIG. 16(c), the Li_{1.15}Mn_{0.6}Ni_{0.2}O_{1.975} (700° C.) and the Li_{1.1}Mn_{0.6}Ni_{0.2}O_{1.95} (700° C.) show lower charge capacities due to the lower Li content of these materials. In the ideal, fully-charged state, the electrodes are expected to have the same composition, Mn_{0.75}Ni_{0.25}O₂, identical to the fully delithiated Li_{1.2}Mn_{0.6}Ni_{0.2}O₂. Therefore, the discharge capacities of these electrodes are expected to be the same. The discharge voltage profiles of FIG. 16(b) and FIG. 16(c), however, show that Li_{1.15}Mn_{0.6}Ni_{0.2}O_{1.975} (700° C.) and Li_{1.1}Mn_{0.6}Ni_{0.2}O_{1.95} (700° C.) have a discharge capacity of 240 mAhg⁻¹ and217 mAhg⁻¹, respectively. Also, the initial capacity of Li_{1.1}Mn_{0.6}Ni_{0.2}O_{1.95} (700° C.) is noticeably lower than the theoretical value, for undetermined reasons.

The “Li₂MnO₃-type” Li_{1.15}Mn_{0.6}Ni_{0.2}O_{1.975} (800° C.) and Li_{1.1}Mn_{0.6}Ni_{0.2}O_{1.95} (800° C.) materials had significantly lower capacities compared to powders of the same composition that were annealed at 700° C. In particular, Li_{1.1}Mn_{0.6}Ni_{0.2}O_{1.95} (800° C.) has the lowest charge/discharge capacities among all the electrodes tested—about 50-100 mAhg⁻¹. The low capacity of Li₂MnO₃-type materials has been reported for Li-rich cathode materials⁷ and Li₂MnO₃ made at high temperatures.^{14,15} Moreover, the charge/discharge voltage profiles in FIG. 16(b) and FIG. 16(c) for the 800° C. powder show severe polarization, indicating extremely slow reaction kinetics. This suggests that the phase transformation from R 3̅m to C2/m may induce a kinetic barrier for Li intercalation/deintercalation.

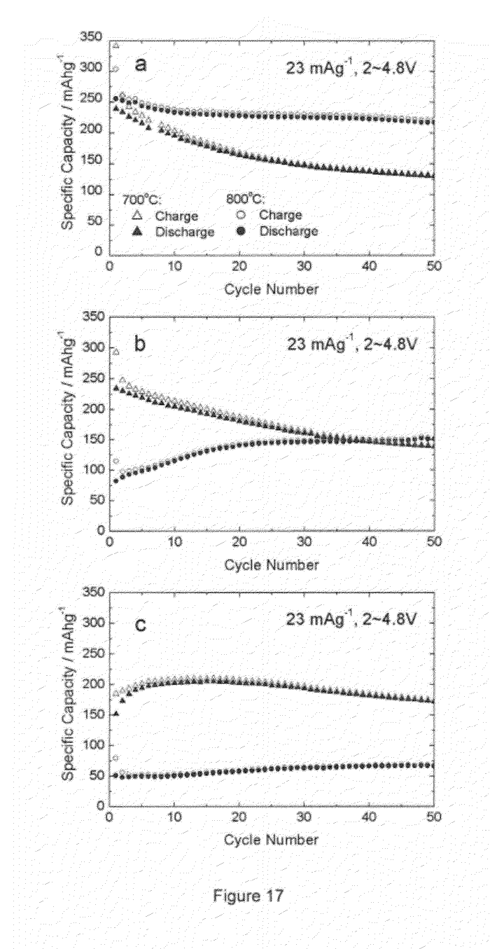

The cycling performance of the electrodes was tested at a current density of 23 mAg⁻¹ with a cut-off voltage between 2.0 and 4.8 V. In general, the powders annealed at 800° C. showed better capacity retention compared to those annealed at 700° C. as shown in FIG. 17. Li_{1.2}Mn_{0.6}Ni_{0.2}O₂ (800° C.) had a capacity of 256 mAhg⁻¹ at the first cycle with a coulombic efficiency of 84%. In the following cycles, both the charge and discharge capacities dropped and stabilized at roughly 225 mAhg⁻¹, with an average coulombic efficiency that was above 98%. Li_{1.2}Mn_{0.6}Ni_{0.2}O₂ (700° C.), having a spinel-type LT-LiCoO₂ structure, showed a lower discharge capacity of 240 mAhg⁻¹ with a coulombic efficiency of 70% at the first cycle but the capacity faded very fast despite having a high efficiency. In fact, at the fiftieth cycle, the electrode only retained 54% of its initial capacity with a 99% coulombic efficiency. Capacity fading was also observed for the Li_{1.15}Mn_{0.6}Ni_{0.2}O_{1.975} (700° C.) electrode, which has a crystal structure that is similar to that of Li_{1.2}Mn_{0.6}Ni_{0.2}O₂ (700° C.) (see FIG. 11(a) and FIG. 11(b)). After the fiftieth cycle, the Li_{1.15}Mn_{0.6}Ni_{0.2}O_{1.975} (700° C.) electrode had a capacity of only 140 mAhg⁻¹, that is 59% of its initial capacity. A similar result has been reported for the Li[Ni_{1/3}Li_{1/9}Mn_{5/9}]O₂ and Li[Ni_{1/2}Mn_{1/2}]O₂ electrodes with the spinel-type LT-LiCoO₂ structure.^{1,16}

The capacity fading for the materials annealed at 700° C. is suppressed in Li_{1.1}Mn_{0.6}Ni_{0.2}O_{1.95} (700° C.) with the integrated layered-spinel structure as indicated in FIG. 17(c). The initial capacity of Li_{1.1}Mn_{0.6}Ni_{0.2}O_{1.95} (700° C.) is only 150 mAhg⁻¹ at a constant current density of 23 mAg⁻¹ between 2.0 and 4.8 V. After a few cycles, the capacity increases to 200 mAhg⁻¹, which is still much lower than its theoretical value and inferior to layered Li_{1.2}Mn_{0.6}Ni_{0.2}O₂ (800° C.). The reason for the poor capacity has not been determined. The coulombic efficiency of the layered-spinel increases from about 82% in the first cycle to about 99% at the fortieth cycle. The coulombic efficiency is slightly higher than that of the layered Li_{1.2}Mn_{0.6}Ni_{0.2}O₂ (800° C.), possibly because of the more spinel structures in the composite.

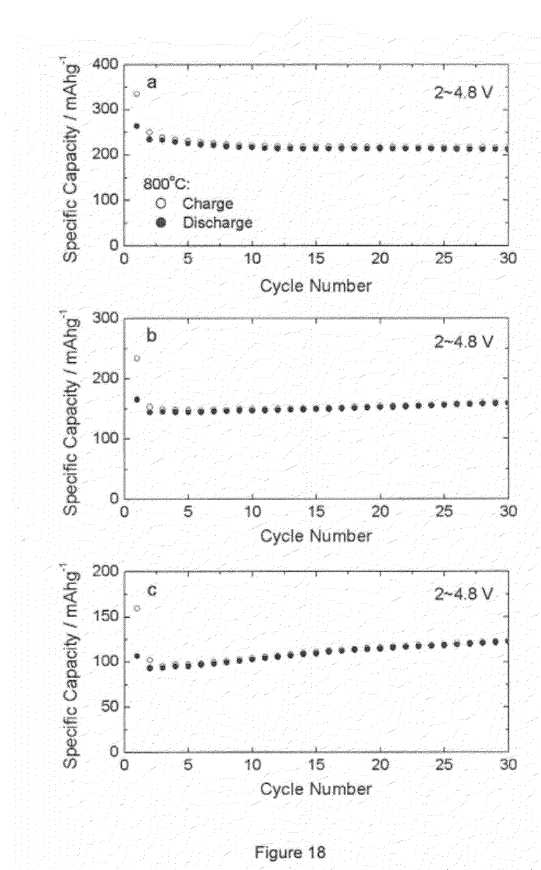

Li₂MnO₃-type Li_{1.15}Mn_{0.6}Ni_{0.2}O_{1.975} (800° C.) and Li_{1.1}Mn_{0.6}Ni_{0.2}O_{1.95} (800° C.) have shown very low initial capacity at 23 mAg⁻¹ as shown in FIG. 17(b) and FIG. 17(c). The capacity does, however, increase slowly over repeated cycles for Li_{1.1}Mn_{0.6}Ni_{0.2}O_{1.95} (800° C.). To electrochemically activate the electrodes, all three electrodes made from the cathode powders annealed at 800° C. were charged and discharged at 11.5 mAg⁻¹ between 2.0 and 4.9 V for the first cycle and then switched back to 23 mAg⁻¹ between 2.0 and 4.8 V for future cycles. As shown in FIG. 18(b) and FIG. 18(c), the “activated” Li_{1.15}Mn_{0.6}Ni_{0.2}O_{1.975} (800° C.) has a relatively constant discharge capacity of 150 mAhg⁻¹ and the capacity of Li_{1.1}Mn_{0.6}Ni_{0.2}O_{1.95} (800° C.) increased from about 50 mAhg⁻¹ to about 120 mAhg⁻¹. No significant capacity increase was observed for Li₁,₁₅Mn_{0.6}N1_{0.2}O_{1.975} (800° C.), which indicates a successful activation under this condition. In contrast, the Li_{1.2}Mn_{0.6}Ni_{0.2}O₂ (800° C.) activated at 11.5 mAg⁻¹ only holds about 200 mAhg⁻¹ in subsequent cycles (see FIG. 18(a)); lower than that for the non-activated electrodes. A possible reason for this is the structure change or damage when the Li concentration was over-depleted during the initial charge process for the layered-type electrode.¹⁰ In view of the foregoing, it is believed that the activation is an important factor in attempting to maximize the cycle life and capacity for Li-rich mix-layered or layered-spinel materials.

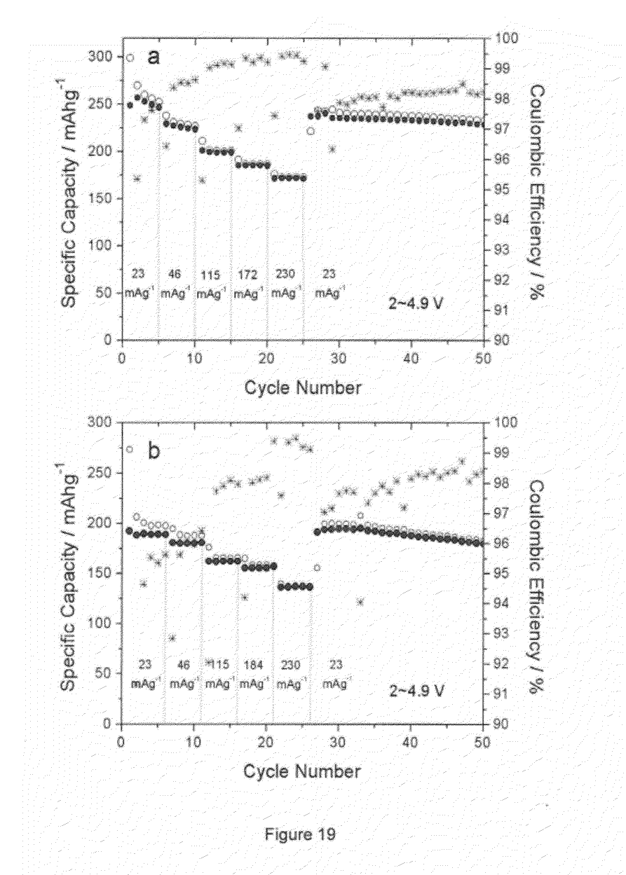

Li_{1.2}Mn_{0.6}Ni_{0.2}O₂ (800° C.) and Li_{1.1}Mn_{0.6}Ni_{0.2}O_{1.95} (700° C.) were selected for rate performance test because both of them showed high capacities and good capacity retention. A slightly higher cut-off voltage 4.9 V was selected for the complete activation of the electrode in the rate performance test. As seen in FIG. 19, starting at a constant current of 23 mAg⁻¹, the current density was increased every five cycles until it reached 230 mAg⁻¹ and then it was switched back to 23 mAg⁻¹ for the later cycles. As previously observed, the coulombic efficiency of both electrodes increased for the first few cycles before reaching an “efficiency plateau”. At a constant current density of 115 mAg⁻¹, Li_{1.2}Mn_{0.6}Ni_{0.2}O₂ (800° C.) delivered roughly 200 mAhg⁻¹ with about 99% efficiency (FIG. 19(a)). Normalized by the discharge capacity at the first cycle (250 mAhg⁻¹), the capacity retention was 80% at a 115 mAg⁻¹ discharge rate. When the current density was increased to 230 mAg⁻¹, the cell was able to supply only 170 mAhg⁻¹ with a very high efficiency of about 99.5%. The normalized capacity retention was about 70%. No severe irreversible capacity loss was observed. After switching back to 23 mAg⁻¹, the Li_{1.2}Mn_{0.6}Ni_{0.2}O₂ (800° C.) electrodes still supplied about 240 mAhg⁻¹ with an average efficiency of 98.2%.

The performance of the Li_{1.1}Mn_{0.6}Ni_{0.2}O_{1.95} (700° C.) electrode was very similar to that of the Li_{1.2}Mn_{0.6}Ni_{0.2}O₂ (800° C.) electrode, except for the lower capacities it was able to supply as shown in FIG. 19(b). At a current density of 115 mAg⁻¹ and 230 mAg⁻¹, the normalized capacities were 84% and 69%, respectively. When charged to 4.9 V, the Li_{1.1}Mn_{0.6}Ni_{0.2}O_{1 95} (700° C.) cell was observed to reach about 200 mAhg⁻¹ immediately without a long activation process. One possible reason for this is that charging to 4.9 V may have depleted the Li concentration to its proper level and contributed to the electrochemical activation. Nevertheless, at elevated C-rates, Li_{1.1}Mn_{0.6}Ni_{0.2}O_{1.95} (700° C.) showed inferior coulombic efficiencies compared to Li_{1.2}Mn_{0.6}Ni_{0.2}O₂ (800° C.). In summary, the Li_{1.2}Mn_{0.6}Ni_{0.2}O₂ (800° C.) powder with the highly mesoporous morphology showed better performance with respect to energy density, rate capability, and efficiency. Therefore, it is believed that the spinel-layered structure does not significantly contribute to the rate capability and efficiency.

### Conclusions

Li_{1.2}Mn_{0.6}Ni_{0.2}O₂ retained the R 3̅m structure after the 800° C. anneal and had a layered-layered integrated structure. With the stoichiometric Li content, layered R 3̅m Li_{1.2}Mn_{0.6}Ni_{0.2}O₂ showed the best electrochemical performance with regards to capacity, capacity retention, rate performance and efficiency. The Li_{1.2}Mn_{0.6}Ni_{0.2}O₂ powder that displayed the best rate-capability has a nano-structured morphology—mesoporous secondary particles composed of nano-sized primary particles that allows for a shorter Li diffusion distance. At the lower 700° C. annealing temperature, Li_{1.2}Mn_{0.6}Ni_{0.2}O₂ had a spinel-type LT-LiCoO₂ structure, which is believed to be due to exchange/mixing of Li⁺ and Ni²⁺ ions in the transition metal layers.

With decreasing Li content, a layered-spinel integrated structure was observed for Li_{1.1}Mn_{0.6}Ni_{0.2}O_{1.95} (700° C.). Li_{1.1}Mn_{0.6}Ni_{0.2}O_{1.95} (800° C.) and Li_{1.15}Mn_{0.6}Ni_{0.2}O_{1.975} (800° C.) underwent a phase transformation to form a Li₂MnO₃-type structure. The integrated layered-spinel structure: Li_{1.1}Mn_{0.6}Ni_{0.2}O_{1.95} did not show superior electrochemical performance. These Li₂MnO₃-type materials had a very high activation barrier for Li transportation and poor capacities and rate capabilities.

### Example 2

The above-described spray pyrolysis method was performed with a precursor solution was comprising metal nitrates dissolved in deionized water where the composition of metals nitrates in the precursor solution was prepared to yield Li_{1.2}Mn_{0.53}Ni_{0.13}Co_{0.13}O₂and 2.5 M. Upon being subjecting this solution to spray pyrolysis, a layered-layered composite with the alternative formula 0.5Li₂MnO₃.0.5Li(Ni_{1/3}Mn_{1/3}Co_{1/3})O₂ was to have been formed. In this example, the precursor solution was aerosolized with a SONAER ultrasonic nebulizer, which has the larger size distribution shown in FIG. 2. The preheater (dryer) temperature was 200° C. and the tube furnace wall temperature was 550° C. The air flow rate through the ultrasonic nebulizer was 6 liters per minute. The powder collected was subjected to a heat treatment of 900° C. for 2 hours.

To prepare the positive electrode, the active material (i.e., Li_{1.2}Mn_{0.53}Ni_{0.13}Co_{0.13}O₂or, alternatively, 0.5Li₂MnO₃.0.5Li(Ni_{1/3}Mn_{1/3}Co_{1/3})O₂), 12 wt % polyvinylidene fluoride (PVdF) binder in N-methyl-2-pyrrolidene (NMP) (Sigma Aldrich), and Super-P conductive carbon black (available from TIMCAL) were blended at a ratio of about 80:10:10 by mass, suspended in NMP, and then homogenized to form a slurry in accordance with the following steps.
1. For a desired batch size, active material powder and Super-P carbon were added to a mixer jar in according to the desired ratio for a desired batch size (e.g., for a 2.5 g batch, this was 2 g of active material and 0.25 g of Super-P carbon).
2. PVdF binder solution was added to the powder mixture in the desired ration (e.g., for a 2.5 g batch, this was 2.08 g of 12% wt PVdF solution).
3. NMP solvent was dripped into the mixture (about 1.25-1.38 g NMP for the 2.5 g batch).
4. The mixer jar was sealed and placed in the mixer (e.g., a planetary centrifugal mixer) and mixed at 2000 rpm for 2 to 3 minutes followed by defoaming at 2200 rpm for 30 seconds.
5. The resulting slurry was checked to confirm it was well mixed (a well-mixed slurry should have a uniform color and display moderate flow ability with high viscosity).
6. If a mixture showed non-uniformity, dry powders, or immobility, 0.1˜0.2 g NMP is added and the mixture is remixed until a well-mixed PE slurry is observed.

The slurry was then cast on aluminum foil (21 microns) using the doctor blade technique to form a thin cathode film according to the following steps.
7. The casting speed of the film casting machine was set at 4˜6 (20-30 cm min⁻¹).
8. The perforated vacuum surface on top of the casting machine and the Al foil were cleaned using acetone; the Al foil was flattened/smoothed on the casting table; (roughening the current collector surface can enhance the adhesion of cathode film to the current collector to maintain a good lamination during drying).
9. The surface was cleansed with acetone-wetted KIMWIPES and the acetone was allowed to evaporate in air before casting (typically, wait for 5 to 10 min).
10. The 100, 150, and 200 μm film applicators/doctor blades are normally applied for thin film preparation.
11. The film was cast at a constant speed (20-30 cm min⁻¹); the thin film should be a smooth, shining-wet coating on the current collector.
12. After the cathode film was cast, the wet electrode was transferred onto a flat glass board, making sure film remained flat.
13. The wet coating was dried at 75° C. for 2-4 hours in air in an oven to bake out the NMP.
14. The dried cathode film was removed from the oven and transferred into a vacuum oven for overnight drying at 120-130° C. under vacuum.

After the electrode film is dried, electrode discs were prepared according to the following steps.
15. Electrode discs 9/16 of inch (14.3 mm) in diameter were punched out of the film on a cutting board (this can be done in open air environment).
16. The electrode discs may be calendered using the calendering press; the calendered electrode can be 30% to 100% of the original thickness (calender ratio, t/t₀) depending on the target porosity (the Example 1 electrodes were lightly calendered to 60-70% of original thickness) (the calendering process can be done in an open air environment).
17. The electrode discs are weighed individually and stored in an UHP-argon filled glove box before cell fabrication.
18. The active material loading may be within the range of 2 to 12 mg/cm².
   A film, which was tested at room temperature (see below), had a loading of 2.2 mg/cm² and calender ratio)(t/t⁰ of 35-70% and another film, which was tested at 55° C. (see below) had a loading of 2.7 mg/cm² and calender ratio (t/t⁰) of 35-70% cathode film.

The PE discs were then assembled into a coin half-cell in an UHP-argon-filled glove box (oxygen level <10 ppm), wherein the electrodes are single sided and assembled as a single stack in a planar cell configuration. The materials used were coin cell parts (2032 type), including coin cell cases (top and bottom), spring, gasket, and 0.5 mm spacer available from Hohsen Corp.; anodes that were lithium foil disc ( 9/16 inch diameter), cathodes that were the above-described PE discs; a separator (Celgard 2325); and electrolyte that was GEN II, A42 available from Tomiyama's High Purity Chemicals. The coin cells were assembled according to the following steps.
19. A gasket and a spacer (height =0.5 mm) were placed into the bottom coin cell case, with the space centered.
20. A drop of electrolyte was placed on the spacer using a 5 ml disposable pipette.
21. The PE was placed on the spacer (centered) with the active material facing up.
22. Approximately 4-6 drops of electrolyte was added until the PE was fully wetted.
23. A Celgard separator was placed (centered) on the wet electrode and any bubbles were removed.
24. Two more drops of electrolyte were added to the top of separator until both components were fully wetted.
25. The NE lithium foil disc (9/16 inch diameter) was placed on top of the separator.;
26. A second spacer was placed on top of the NE (centered) and a spring was placed on top of the 2nd spacer (centered); efforts should be made to assure that all parts of the cell remain centered, including the top enclosure;
27. A cap was placed and excess electrolyte was removed from the surface of the cell case with a KIMWIPE.
28. The cell was sealed using an automatic or manual coin-cell crimper.

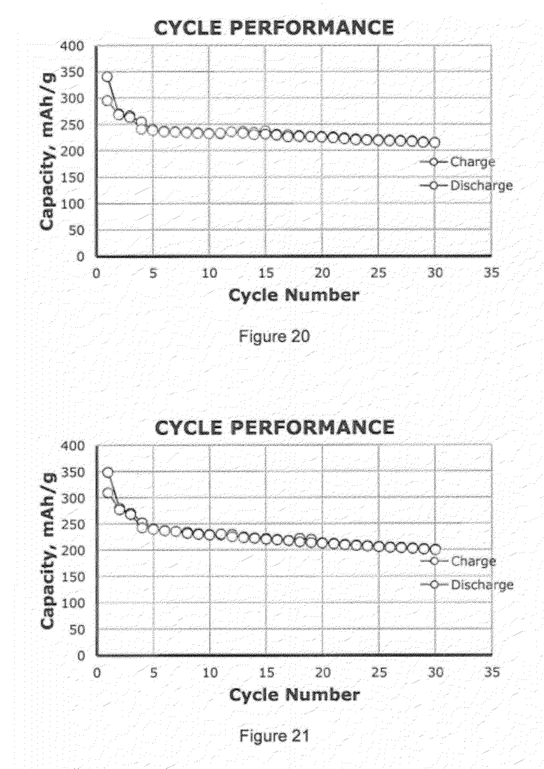

After assembling the coin cell, it was allowed to rest for at least 2 hours before being subjected to electrochemical testing. The electrochemical performance was tested at room temperature and at 55° C. The test procedure involved activation at C/24 for charge and discharge with an OCV of about 4.8V. The second and third cycles were conducted at C/10 for charge and discharge between 2 and 4.6V. The fourth through one hundredth cycles were conducted at C/3 for both charge and discharge between 2 and 4.6V. The cycling performance for this coin cell is shown in FIG. 20. At room temperature, the initial capacity is nearly 300 mAh/g and after 30 cycles the capacity is 210 mAh/g at C/3. The results of the cycling tests performed at 55° C. are set forth in FIG. 21 and indicate an initial discharge capacity of 305 mAh/g and just over 200 mAh/g after 30 cycles.

References
1. Z. H. Lu, D. D. MacNeil, J. R. Dahn, Layered Cathode Materials Li[NiₓLi_{(1/3-2x/3)}Mn_{(2/3-x/3)}]O₂ for Lithium-Ion Batteries, Electrochem. Solid-State Lett., 4 (2001) A191-A194.
2. Z. H. Lu, L. Y. Beaulieu, R. A. Donaberger, C. L. Thomas, J. R. Dahn, Synthesis, Structure, and Electrochemical Behavior of Li[NiₓLi_{1/3-2x/3}Mn_{2/3-x/3}]O₂, J. Electrochem. Soc., 149 (2002) A778-A791.
3. C. S. Johnson, J. S. Kim, C. Lefief, N. Li, J. T. Vaughey, M. M. Thackeray, The significance of the Li₂MnO₃ component in ‘composite’ xLi₂MnO₃.(1−x)LiMn_{0.5}Ni_{0.5}O₂ electrodes, Electrochem. Commun., 6 (2004) 1085-1091.
4. M. M. Thackeray, S. H. Kang, C. S. Johnson, J. T. Vaughey, R. Benedek, S. A. Hackney, Li₂MnO₃-stabilized LiMO₂ (M=Mn, Ni, Co) electrodes for lithium-ion batteries, J. Mater. Chem., 17 (2007) 3112-3125.
5. C. S. Johnson, N. Li, J. T. Vaughey, S. A. Hackney, M. M. Thackeray, Lithium-manganese oxide electrodes with layered-spinel composite structures xLi₂MnO₃.(1−x)Li_{1+y}Mn_{2-y}O₄ (0<x<1, 0≦y≦0.33) for lithium batteries, Electrochem. Commun., 7 (2005) 528-536.
6. S. H. Park, S. H. Kang, C. S. Johnson, K. Amine, M. M. Thackeray, Lithium-manganese-nickel-oxide electrodes with integrated layered-spinel structures for lithium batteries, Electrochem. Commun., 9 (2007) 262-268.
7. H. X. Deng, I. Belharouak, Y. K. Sun, K. Amine, LiₓNi_{0.25}Mn_{0.75}O_{y} (0.55≦x≦2, 2≦y≦2.75) compounds for high-energy lithium-ion batteries, J. Mater. Chem., 19 (2009) 4510-4516.
8. H. X. Deng, I. Belharouak, R. E. Cook, H. M. Wu, Y. K. Sun, K. Amine, Nanostructured lithium nickel manganese oxides for lithium-ion batteries, J. Electrochem. Soc., 157 (2010) A447-A452.
9. C. S. Johnson, J. S. Kim, A. J. Kropf, A. J. Kahaian, J. T. Vaughey, M. M. Thackeray, The Role of Li₂MO₂ Structures (M=Metal Ion) in the Electrochemistry of (x)LiMn_{0.5}Ni_{0.5}O₂.(1−x)Li₂TiO₃ Electrodes for Lithium-Ion Batteries, Electrochem. Commun., 4 (2002) 492-498.
10. H. F. Wang, Y. I. Jang, B. Y. Huang, D. R. Sadoway, Y. T. Chiang, TEM study of electrochemical cycling-induced damage and disorder in LiCoO₂ cathodes for rechargeable lithium batteries, J. Electrochem. Soc., 146 (1999) 473-480.
11. F. Amalraj, D. Kovacheva, M. Talianker, L. Zeiri, J. Grinblat, N. Leifer, G. Goobes, B. Markovsky, D. Aurbach, Synthesis of Integrated Cathode Materials xLi₂MnO₃.(1−x)LiMn_{1/3}Ni_{1/3}Co_{1/3}O₂ (x=0.3, 0.5, 0.7) and Studies of Their Electrochemical Behavior, J. Electrochem. Soc., 157 (2010) A1121-A1130.
12. L. Dupont, M. Hervieu, G. Rousse, C. Masquelier, M. R. Palacin, Y. Chabre, J. M. Tarascon, TEM Studies: The Key for Understanding the Origin of the 3.3 V and 4.5 V Steps Observed in LiMn₂O₄-Based Spinets, J. Solid State Chem., 155 (2000) 394-408.
13. C. S. Johnson, N. C. Li, C. Lefief, M. M. Thackeray, Anomalous capacity and cycling stability of xLi₂MnO₃.(1−x)LiMO₂ electrodes (M=Mn, Ni, Co) in lithium batteries at 50° C., Electrochem. Commun., 9 (2007) 787-795.
14. A. D. Robertson, P. G. Bruce, Mechanism of electrochemical activity in Li₂MnO₃, Chem. Mater., 15 (2003) 1984-1992.
15. D. Y. W. Wu, K. Yanagida, Y. Kato, H. Nakamura, Electrochemical Activities in Li₂MnO₃, J. Electrochem. Soc., 156 (2009) A417-A424.
16. Z. H. Lu, D. D. MacNeil, J. R. Dahn, Layered Li[NiₓCo₁₋₂ₓMnₓ]O₂ Cathode Materials for Lithium-Ion Batteries, Electrochem. Solid-State Lett., 4 (2001) A200-A203.
17. X. Zhang, H. Zheng, V. Battaglia, and R. Axelbaum, Electrochemical performance of spinel LiMn₂O₄ cathode materials by flame-assisted spray technology, JOURNAL OF POWER SOURCES 196 (2011) 3640-3645 (which is incorporated herein in its entirety by reference).
18. N. Kumagai, T. Saito, S. Komaba, J. APPL. ELECTROCHEM. 30 (2000) 159-163.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

All ranges discussed can and do necessarily also describe all subranges therein for all purposes and that all such subranges are part this invention. Any listed range can be easily recognized as sufficiently describing and enabling the same range being broken down into at least equal halves (e.g., a lower half and upper half), thirds, quarters, tenths, etc.

What is claimed is:

1. A material comprising a plurality of metal oxide secondary particles that comprise metal oxide primary particles, which comprise a metal oxide having a general chemical formula Li_{i+α}(NiₓCo_{y}Mn_{z})₁₋ₜMₜO_{2-d}R_{d}, wherein:
M is selected from a group consisting of Al, Mg, Fe, Cu, Zn, Cr, Ag, Ca, Na, K, In, Ga, Ge, V, Mo, Nb, Si, Ti, Zr, and mixtures thereof;
R is selected from a group consisting of F, Cl, Br, I, H, S, N, and mixtures thereof; and
0≦α≦0.50; 0<x≦1; 0≦y≦1; 0<z≦1; 0≦t≦1; and 0≦d≦0.5; and
wherein the primary particles have a size that is in the range of about 1 nm to about 10 μm; and
wherein the secondary particles are mesoporous and have a size that is in the range of about 10 nm to about 100 μm and a sphericity of at least about 0.95.

2. The material of claim 1, wherein the secondary particles have an inter-primary particle spacing that is in the range of about 2 nm to about 100 nm.

3. The material of claim 1, wherein the secondary particles have a Brunnauer-Emmett-Teller surface area that is in the range of about 1 m²/g to about 30 m2/g.

4. The material of claim 1, wherein:
M is selected from a group consisting of Al, Mg, Fe, Cu, Zn, Cr, Ag, Ca, Na, K, Si, Ti, V, and mixtures thereof; and
R is selected from a group consisting of F, Cl, Br, I, and mixtures thereof.

5. The material of claim 1, wherein the primary particles comprise Li_{1+α}NiₓMn_{z}O₂, wherein 0≦α≦0.2, 0.1≦x≦0.6, and 0.2≦z≦0.6.

6. The material of claim 1, wherein the metal oxide has a composite chemical formula xLi₂MO₃.(1−x)LiM′O₂, wherein:
M is one or more metallic ions having an average oxidation state of +4; and
M′ is one or more metallic ions have an average oxidation state of +3; and 0<x<1.

7. The material of claim 6, wherein M is Mn and M′ is selected from the group consisting of Mn, Ni, Co, Cr, and combinations thereof.

8. The material of claim 6, wherein M is Mn and M′ comprises at least one of Mn and Ni.

9. The material of claim 6, wherein M is Mn and M′ is Mn and Ni.

10. The material of claim 6, wherein M is Mn and M′ is Mn_{0.25-0.75} and Ni_{0.25-0.75}.

11. The material of claim 6, wherein the metal oxide composite formula is xLi₂MnO₃.(1−x)LiMn_{0.5}Ni_{0.5}O₂ and 0.3≦x≦0.7.

12. The material of claim 11, wherein x=0.3 and the metal oxide has a layered-layered composite structure.

13. The material of claim 6, wherein the metal oxide composite formula is xLi₂MnO₃.(1−x)LiCoO₂ and 0.3≦x≦0.7.

14. The material of claim 6, wherein the metal oxide composite formula is xLi₂MnO₃.(1−x)LiMn_{1/3}Ni_{1/3}Co_{1/3}O₂and 0.3≦x≦0.7.

15. The material of claim 6, wherein the metal oxide has a layered-layered composite crystal structure.

16. The material of claims 6, wherein the metal oxide comprises a layered-spinel composite crystal structure.

17. The material of claim 6, wherein the metal oxide comprises a spinel-type (LT-LiCoO₂-type) crystal structure.

18. The material of claim 6, wherein the metal oxide comprises a monoclinic Li₂MnO₃-type crystal structure.

19. The material of claim 1, wherein at least 95% of the material is the metal oxide secondary particles.

20. The material of claim 1, wherein the relative concentration of each element within any 1 micrometer region of the material does not vary more than about 4% from the mean and that the standard deviation throughout the material is no greater than about 4%.

21. The material of claim 1, wherein the relative concentration of each element within any 1 micrometer region of the material does vary more than about 1% from the mean and the standard deviation throughout the material is no greater than about 1%.

22. The material of claim 1, wherein the primary particles have a mean size that is in the range of about 1 nm to about 500 nm and the secondary particles have a mean size that is in the range of about 0.1 μm to about 20 μm and the standard deviation with respect to the median size for the secondary particles is in the range about 0 to about 10.

23. The material of claim 1, wherein the primary particles have a mean size that is in the range of about 500 nm to about 10 μm and the secondary particles have a mean size that is in the range of about 1 μm to about 100 μm and the standard deviation with respect to the median size for the secondary particles is in the range about 0 to about 10.

24. A process for preparing a metal oxide material, the process comprising: aerosolizing a precursor solution that comprises compounds that are precursors to the metal oxide material in a solvent to form droplets that comprise the precursor solution;
evaporating the solution in the droplets to form dried droplets that comprise the precursor compounds; calcining the dried droplets to form the metal oxide material that comprises a plurality of metal oxide secondary particles that comprise metal oxide primary particles, which comprise a metal oxide having a general chemical formula Li_{1-α}(NiₓCo_{y}Mn_{z})₁₋ₜMₜO_{2-d}R_{d}, wherein:
M is selected from a group consisting of Al, Mg, Fe, Cu, Zn, Cr, Ag, Ca, Na, K, In, Ga, Ge, V, Mo, Nb, Si, Ti, Zr, and mixtures thereof;
R is selected from a group consisting of F, Cl, Br, I, H, S, N, and mixtures thereof; and
0≦α≦0.50; 0<x≦1; 0≦y≦1; 0<z≦1; 0≦t≦1; and 0≦d≦0.5; and
wherein the primary particles have a size that is in the range of about 1 nm to about 10 μm; and
wherein the secondary particles are mesoporous and have a size that is in the range of about 10 nm to about 100 μm and a sphericity of at least about 0.95.

25. The process of claim 24, wherein the precursor solution has a concentration of precursor compounds that is up to about 10 mole/L.

26. The process of claim 24, wherein the precursor compounds comprise nitrates of the metallic elements of the metal oxide.

27. The process of claim 24, wherein the droplets are of a size that is in the range of about 0.1 μm to about 1000 μm.

28. The process of claim 24, wherein the drying of the droplets comprises heating the droplets to a temperature that is about that of the solvent boiling point.

29. The process of claim 24, wherein the precursors compounds are selected such that when combined in the precursor solution they decompose at temperatures within about 300° C. of each other and that are below the evaporation temperature for the metallic elements of the metal oxide.

30. The process of claim 29, wherein the precursor solution comprises LiNO₃, Mn(NO₃)₂, and Ni(NO₃)₂.

31. The process of claim 29, wherein calcination is performed at a temperature sufficient to decompose all the precursor compounds and below the evaporation temperature for the metallic elements of the metal oxide.

32. The process of claim 29, wherein the calcination temperature is within a range of about 300 to about 1000° C. for a duration that is no greater than about 1000 seconds.

33. The process of claim 24 further comprising annealing the metal oxide material to cause crystallite growth and coarsening in the metal oxide material and affect the crystal structure of the metal oxide material, wherein the primary particles of the annealed metal oxide material have a size that is in the range of about 1 nm to about 10 μm and the secondary particles of the annealed metal oxide material have a size that is in the range of about 10 nm to about 100 μm and are mesoporous.

34. The process of claim 33, wherein the metal oxide material is annealed at a temperature within a range of about 300 to about 1000° C. for a duration that is within a range of about 30 minutes to about 48 hours.

35. The process of claim 33, wherein the metal oxide material is annealed at a temperature within a range of about 700 to about 800° C. for a duration that is within a range of about 2 hours to about 10 hours.

36. The process of claim 33 further comprising cooling the annealed metal oxide material at a rate sufficiently slow so as to inhibit formation of defects in the metal oxide.

37. The process of claim 36 wherein the rate is no greater than about 5° C./min.

38. A battery comprising a negative electrode, an electrolyte, and a positive electrode that comprises a metal oxide material, wherein the metal oxide material comprises a plurality of metal oxide secondary particles that comprise metal oxide primary particles, which comprise a metal oxide having a general chemical formula Li_{1+α(Ni}ₓCo_{y}Mn_{z})₁₋ₜMₜO_{2-d}R_{d}, wherein:
M is selected from a group consisting of Al, Mg, Fe, Cu, Zn, Cr, Ag, Ca, Na, K, In, Ga, Ge, V, Mo, Nb, Si, Ti, Zr, and mixtures thereof;
R is selected from a group consisting of F, Cl, Br, I, H, S, N, and mixtures thereof; and
0≦α≦0.50; 0<x≦1; 0≦y≦1; 0<z≦1; 0≦t≦1; and 0≦d≦0.5; and
wherein the primary particles have a size that is in the range of about 1 nm to about 10 μm; and
wherein the secondary particles are mesoporous and have a size that is in the range of about 10 nm to about 100 μm and a sphericity of at least about 0.95.

39. A metal oxide material produced by a process comprising: aerosolizing a precursor solution that comprises compounds that are precursors to the metal oxide material in a solvent to form droplets that comprise the precursor solution; evaporating the solution in the droplets to form dried droplets that comprise the precursor compounds; calcining the dried droplets to form the metal oxide material that comprises a plurality of metal oxide secondary particles that comprise metal oxide primary particles, which comprise a metal oxide having a general chemical formula Li_{1+α}(NiₓCo_{y}Mn_{z})₁₋ₜMₜO_{2-d}R_{d}, wherein:
M is selected from a group consisting of Al, Mg, Fe, Cu, Zn, Cr, Ag, Ca, Na, K, In, Ga, Ge, V, Mo, Nb, Si, Ti, Zr, and mixtures thereof;
R is selected from a group consisting of F, Cl, Br, I, H, S, N, and mixtures thereof; and
0≦α≦0.50; 0<x≦1; 0≦y≦1; 0<z≦1; 0≦t≦1; and 0≦d≦0.5; and
wherein the primary particles have a size that is in the range of about 1 nm to about 10 μm; and
wherein the secondary particles are mesoporous and have a size that is in the range of about 10 nm to about 100 μm and a sphericity of at least about 0.95.

40. The metal oxide material of claim 39, wherein the precursor solution has a concentration of precursor compounds that is in the range of about 2 to about 5 mole/L, the precursor compounds comprise nitrates of the metallic elements of the metal oxide, the droplets are of a size that is in the range of about 0.1 μm to about 1000 μm, the drying of the droplets comprises heating the droplets to a temperature that is about that of the solvent boiling point, and the calcination is performed at a temperature sufficient to decompose all the precursor compounds but below the evaporation temperature for the metallic elements of the metal oxide.

41. The metal oxide material of claim 40, wherein the process further comprises annealing the metal oxide material to cause crystallite growth and coarsening in the metal oxide material and affect the crystal structure of the metal oxide material, wherein the primary particles of the annealed metal oxide material have a size that is in the range of about 1 nm to about 10 μm and the secondary particles of the annealed metal oxide material have a size that is in the range of about 10 nm to about 100 μm and are uniformly mesoporous, and cooling the annealed metal oxide material at a rate sufficiently slow so as to inhibit formation of defects in the metal oxide.

42. The metal oxide material of claim 41, wherein the relative concentration of each element within any 1 micrometer region of the material does not vary more than about 4% from the mean and that the standard deviation throughout the material is no greater than about 4%.

43. The metal oxide material of claim 42, wherein the primary particles have a mean size that is in the range of about 1 nm to about 500 nm and the secondary particles have a mean size that is in the range of about 0.1 μm to about 20 μm, and wherein the standard deviation with respect to the median size for the secondary particles is in the range about 0 to about 10.

44. The metal oxide material of claim 42, wherein the primary particles have a mean size that is in the range of about 500 nm to about 10 μm and the secondary particles have a mean size that is in the range of about 1 μm to about 100 μm, and wherein the standard deviation with respect to the median size for the secondary particles is in the range about 0 to about 10.
